(19) United States
(12) Patent Application Publication
(10) Pub. No.: US 2006/0262337 A1
(43) Pub. Date: Nov. 23, 2006

(54) Image printing apparatus and tandem image printing method

(75) Inventors: Yoshihisa Kamata, Tokyo (JP); Junichi Isamikawa, Tokyo (JP); Masahiro Osawa, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/440,948

(22) Filed: May 25, 2006

(30) Foreign Application Priority Data
Apr. 8, 2005 (JP) 2005-227155

(51) Int. Cl. G06F 3/12

(52) U.S. Cl. 358/1.13

(57) ABSTRACT

This invention provides an image printing apparatus including a communication unit which communicatively connects to at least another image printing apparatus, a tandem output mode, a paper feed unit which feeds recording sheets, a comparison and determination unit which compares the information of recording sheets which can be fed from the paper feed unit with paper size information and paper type information in another image printing apparatus which has received by the communication unit in the tandem output mode, and determines a paper size match/mismatch and a paper type match/mismatch, and a mismatch notification unit which notifies a mismatch when one or both of the paper size and the paper type exhibits a mismatch upon receiving a determination result from the comparison and determination unit.

### CROSS-REFERENCE TO RELATED APPLICATION

This application makes reference to, incorporates the same herein, and claims all benefits accruing under 35 U.S.C. § 119 from an application for “IMAGE PRINTING APPARATUS AND TANDEM IMAGE PRINTING METHOD” earlier filed in the Japanese Patent Office on Aug. 4, 2005 and there duly assigned the Application No. 2005-227155.

### BACKGROUND OF THE INVENTION

1. Field of the Invention

The present invention relates to an image printing apparatus used in a tandem image printing system which prints images by operating a plurality of image printing apparatuses in conjunction with each other, and a tandem image printing method.

2. Description of Related Art

With recent advances in advanced information technology, digitization and networking of image printing apparatuses such as copying machines, printers, and multifunctional devices have been realized. Along with this, a tandem output system technique has been put into practice. According to this technique, a plurality of image printing apparatuses are coupled to each other to quickly copy the document image read by a given one image reader, or a plurality of printers are made to quickly output the image data transmitted from a computer so as to obtain many image outputs within a short period of time. In this tandem output system, set contents (a paper size, density, magnification, and the like) for image printing are shared among the respective image printing apparatuses to obtain the same output contents. An image printing apparatus serving as a master apparatus transmits set contents to image printing apparatuses serving as sub-apparatuses to allow them to share the set values. On the sub side, upon receiving the above set contents, settings are performed in the self-apparatus. On the sub side, image printing is performed upon selecting a recording sheet matching the transmitted set sheet size. Therefore, the master apparatus and the sub-apparatuses need to prepare recording sheets of the same size.

There has also been proposed an image printing system which transmits the paper type information of recording sheets as the above set content, and if the received paper type information of recording sheets differs from the paper type of recording sheets to be used, corrects image quality on the basis of the difference, thereby suppressing an image quality change due to the paper type of recording sheets and reducing the difference between print results (refer to Patent Reference 1: Japanese Unexamined Patent Publication No. 2003-271017).

Various types of recording sheets which differ in paper type, thickness, and the like have recently been used for printed materials, and a printer selectively uses such recording sheets in accordance with customer needs.

In such a case, in order to shorten the time required for image printing, a tandem output system is sometimes used to print by using a plurality of apparatuses. In this case, if a recording sheet is determined only on the basis of a paper size as in the prior art, a desired image cannot be obtained. In a system designed to output images on different types of recording sheets upon image correction, different image printing apparatuses output different types of recording sheets, and hence print results inevitably differ. With a recent tendency to attach importance to print results, a problem inevitably arises in terms of print quality when images are output to different types of recording sheets.

### SUMMARY OF THE INVENTION

The present invention has been made in consideration of the above situation, and can provide an image printing apparatus and a tandem image printing method which can reliably output images onto recording sheets of the same size and same paper type while avoiding a tandem output operation with respect to recording sheets of different paper types.

According to the first main aspect of the present invention, there is provided an image printing apparatus having a tandem output mode which allows trans-mission/reception of image data to/from at least another image printing apparatus through a communication unit for connecting the image printing apparatus to another image printing apparatus so as to allow communication therebetween, thereby allowing a plurality of image printing apparatuses to perform image printing, comprising an image printing unit which prints an image, a paper feed unit which feeds a recording sheet to the image printing unit, a comparison and determination unit which determines a paper size and paper type match/mismatch by comparing paper size information and paper type information of another image printing apparatus which have been received by the communication unit with paper size information and paper type information of a recording sheet which can be fed from the paper feed unit, and a mismatch notification unit which receives a determination result from the comparison and determination unit and notifies a mismatch when one or both of a paper size mismatch and a paper type mismatch has occurred.

According to the first main aspect described above, paper size information and paper type information of another image printing apparatus are received by the communication unit, and the received information is compared with the paper size information and paper type information of recording sheets which can be fed from the paper feed unit of this image printing apparatus to determine matches/mismatches between the paper sizes and the paper types of the two apparatuses. If the determination result indicates a paper size mismatch or a paper type mismatch, the mismatch notification unit notifies another image printing apparatus of the mismatch.

Note that paper sizes which can be used may be standardized sizes such as, for example, A-size and B-size and non-standardized sizes, and the number of paper sizes to be used is not specifically limited. In addition, paper types that can be used include, for example, ordinary paper, fine paper, coated paper, book paper, rough paper, and OHP, and also include a material arbitrarily set by a user as user paper. Other paper types include basis weight, paper color, the presence/absence of punched holes, and the like. However, in the present invention, the contents of a paper type to be used are not limited to any specific contents, and any contents can be set as needed. In addition, the contents of a paper type to be shared may be changed for each tandem output operation.

A plurality of image printing apparatuses are connected to each other through communication units. The communication units can perform one-way or two-way transmission/reception between the respective apparatuses and to/from other information processing apparatuses. The respective image printing apparatuses are generally connected to each other through a network such as a LAN or a dedicated line. In each image printing apparatus, the communication unit incorporates a LAN interface or the like which connects to such a network. Alternatively, the image printing apparatuses may be connected to each other through direct cables or the like.

In the tandem output mode, the respective image printing apparatuses perform image printing in conjunction with each other in accordance with the image data read by one image printing apparatus or externally input image data. The tandem output mode may be always active or may be activated by operating an operation button. Alternatively, an image printing apparatus may be shifted to the tandem output mode upon receiving a tandem output mode setting notification from another image printing apparatus.

The paper feed unit incorporated in the image printing apparatus feeds recording sheets to the image printing unit, and may comprise one or a plurality of paper feed trays. The paper feed trays include a manual paper feed tray and a large-capacity paper feed tray which is located outside the apparatus and can feed a large quantity of recording sheets in addition to the tray in the apparatus. The present invention may include these trays together. Each paper feed tray may be a fixed type designed to select recording sheets which can be fed by setting in advance or an APS (Automatic Paper Selection) type designed to automatically select a paper feed tray having recording sheets matching a designated paper size and paper type. Alternatively, it suffices to arbitrarily switch/set the fixed type and the APS type.

The paper size information and paper type information of recording sheets stored in the paper feed unit may be automatically acquired by using sensors or the like on a paper feed tray. Alternatively, the operator may register in advance the paper size information and paper type information of recording sheets to be stored in the paper feed unit.

In the tandem output mode, the comparison and determination unit which compares/determines the above paper size information and paper type information acquires the information of recording sheets stored in the paper feed unit as data, and determines whether the data matches received information, and comprises a CPU and a program for causing it to operate. According to the present invention, however, this unit is not limited to any specific unit as long as a match/mismatch can be determined.

The notification unit which notifies a mismatch if a comparison and determination result indicates a mismatch varies in arrangement depending on the notification contents, and can notify by sound or can notify another image printing apparatus or terminal of the mismatch through the communication unit. This allows the operator or manager to recognize in the tandem output mode that some image printing apparatus does not match a designated paper size and paper type.

According to the second main aspect of the present invention, there is provided an image printing apparatus having a tandem output mode which allows trans-mission/reception of image data to/from at least another image printing apparatus through a communication unit for connecting the image printing apparatus to another image printing apparatus so as to allow communication therebetween, thereby allowing a plurality of image printing apparatuses to perform image printing, comprising an image printing unit which prints an image, a paper feed unit which feeds a recording sheet to the image printing unit, and a paper feed setting unit which sets a paper size and paper type of a recording sheet to be fed from the paper feed unit, wherein in the tandem output mode, paper size information and paper type information set by the setting unit are transmitted through the communication unit, and when a recording sheet which can be fed in another image printing apparatus which has received the set sheet size information and paper type information does not match one or both of the set sheet size and paper type, a mismatch notification can be received from another image printing apparatus through the communication unit.

According to the second main aspect described above, in the tandem output mode, the image printing apparatus in which the paper size and paper type of recording sheets to be used are set transmits the set information to another image printing apparatus through the communication unit. Another image printing apparatus compares the received set information with the paper size information and paper type information of recording sheets which can be fed by itself. If they do not match, another image printing apparatus transmits a mismatch notification to the image printing apparatus which has transmitted the set information. This allows the image printing apparatus which has transmitted the set information to receive the mismatching notification. Therefore, recording sheet information in another image printing apparatus installed in a different place can be easily known. This makes it possible to quickly perform subsequent processing.

According to the third main aspect of the present invention, there is provided a tandem image printing method of transmitting/receiving image data between a plurality of image printing apparatuses by communicatively connecting the plurality of image printing apparatuses to each other and making the plurality of image printing apparatuses perform image printing, comprising transmitting paper size information and paper type information set in one image printing apparatus to at least another image printing apparatus, causing the other image printing apparatus which has received the set information to compare a paper size and paper type of a recording sheet which can be fed therein with a paper size and paper type based on the received set information, and notifying the image printing apparatus in which the paper size information and paper type information have been set of a mismatch, when one or both of a paper size and a paper type exhibits a mismatch.

According to the third main aspect described above, a plurality of image printing apparatuses exchange paper size information and paper type information and can share them. If, therefore, an image printing apparatus which receives set information cannot feed recording sheets matching the set information of the paper size and paper type, the apparatus can notify a mismatch.

Other subsidiary aspects of the present invention will be described later.

As is obvious from the respective aspects described above, according to the image printing apparatus of the present invention, an image printing apparatus which cannot feed recording sheets which match the paper size and paper type of recording sheets used in the tandem output mode can quickly notify these mismatches, thereby avoiding the tandem output operation with different print results.

According to another image printing apparatus of the present invention, assume that after a given image printing apparatus sets the paper size and paper type of recording sheets to be used in the tandem output operation and transmits them to another image printing apparatus, the other image printing apparatus cannot feed recording sheets matching the recording sheets to be used in the tandem output mode. In this case, these mismatches can be quickly received, and the situation can be quickly grasped. In addition, subsequent necessary processing can be easily performed.

Furthermore, according to the tandem image printing method of the present invention, paper size and paper type settings can be shared between a plurality of image printing apparatuses. If a paper size or paper type mismatch occurs between image printing apparatuses, the situation can be quickly known by notification of the mismatch.

The present invention is more specifically described in the following paragraphs by reference to the drawings attached only by way of example.

### BRIEF DESCRIPTION OF THE DRAWINGS

A more complete appreciation of the present invention, and many other attendant features and advantages thereof, will become readily apparent as the same becomes better understood by reference to the following detailed description when considered in conjunction with the accompanying drawings in which like reference symbols and reference numerals indicate the same or similar components, wherein:

FIG. 1 is a schematic front view showing the overall arrangement of an image printing apparatus according to an embodiment of the present invention;

FIG. 2 is a network connection diagram including a functional block diagram in the embodiment;

FIGS. 3-1 to 3-4 are flowcharts showing sequences of adding/changing recording sheet information in the embodiment;

FIG. 4 is a view of an operation window showing a paper type setting window in the embodiment;

FIG. 5 is a view of an operation window showing a list of registered recording sheet information in the embodiment;

FIG. 6 is a view of an operation window showing a recording sheet information setting window in the embodiment;

FIG. 7 is a view of an operation window showing a window for setting paper type information of recording sheet information in the embodiment;

FIGS. 8-1 to 8-3 are flowcharts showing sequences of changing paper feed/recording sheet information in the embodiment;

FIG. 9 is a view of an operation window for displaying/changing/selecting paper feed/recording sheet information in the embodiment;

FIG. 10 is a view of an operation window for changing paper feed/recording sheet information in the embodiment;

FIG. 11 is a flowchart showing a sequence of changing paper feed/recording sheet information by using registered information in the embodiment;

FIG. 12 is a view of an operation window for changing paper feed/recording sheet information by using registered information in the embodiment;

FIG. 13 is a flowchart showing a sequence for a tandem output method in performing a tandem output operation in the embodiment;

FIG. 14-1 is a flowchart showing a sequence of performing recording sheet match/mismatch determination in the APS mode;

FIG. 14-2 is a flowchart showing a sequence of performing recording sheet match/mismatch determination when a fixed tray is to be used;

FIG. 15 is a view of an operation window in which mismatch notification is performed in the APS mode; and

FIG. 16 is a view of an operation window in which mismatch notification is performed when a fixed tray is used.

### DETAILED DESCRIPTION OF THE PREFERRED EMBODIMENT

A preferred embodiment of an image printing apparatus of the present invention will be described below with reference to the accompanying drawings.

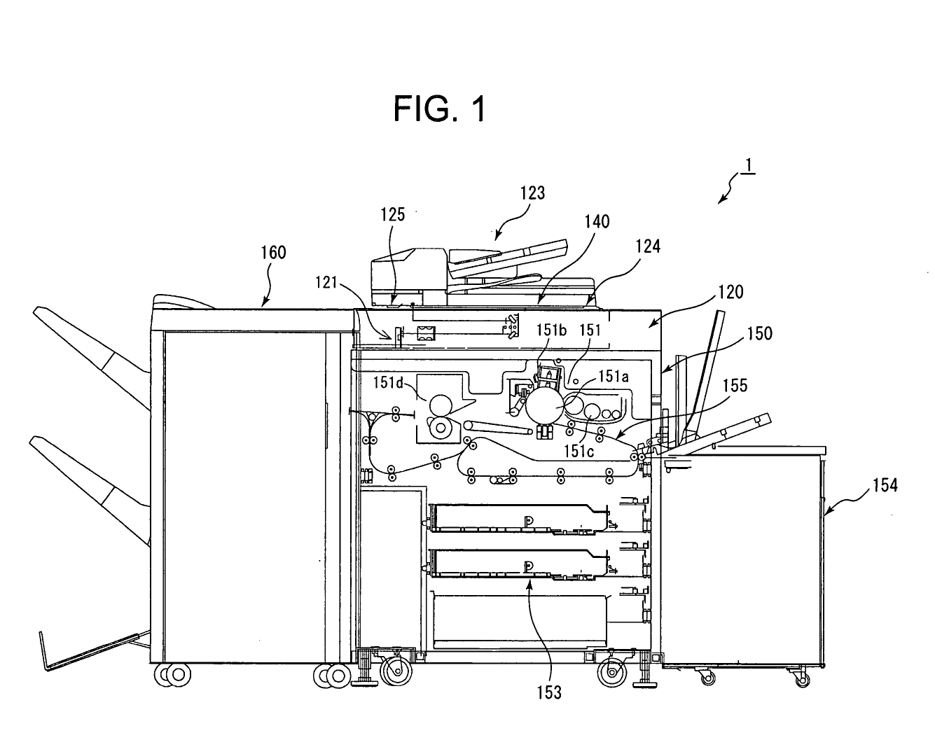

FIG. 1 schematically shows the mechanical structure of an image printing apparatus 1 according to this embodiment. The mechanical structure of the image printing apparatus 1 will be described below with reference to FIG. 1.

On the upper side of the image printing apparatus 1, there are provided a scanner unit 130 including a CCD 131, an automatic document feeder (ADF) 123, a platen glass 124 on which a document is set, and an ADF document read slit glass 125. These components constitute a document reading unit. In addition, on the upper side of the image printing apparatus 1, an operation unit 140 is provided, at a position where the platen glass 124 is not located, to allow an operator to operate.

On the lower side of the image printing apparatus 1, there are provided first to third paper feed trays 153 serving as paper feed trays, and a large-capacity paper feed tray 154 serving as a paper feed tray, which is additionally attached to the image printing apparatus 1. Second feed rollers 155 are placed in a place where sheets are conveyed from these paper feed trays. These components constitute a paper feed unit according to this embodiment. An image printing unit comprising an LD 151 and the like is provided downstream in the convey direction of the second feed roller 155. A printer unit 150 is constituted by the above image printing unit, first to third paper feed trays 153, large-capacity paper feed tray 154, second feed rollers 155, and the like. On the downstream side of the image printing unit, a postprocessing apparatus (FNS) 160 is installed in a delivery area to perform desired postprocessing (stapling, punching, or the like) for recording sheets on which image are printed. The above image printing unit comprises a photosensitive body 151a, charger 151b, developing device 151c, fixing device 151d, and the like.

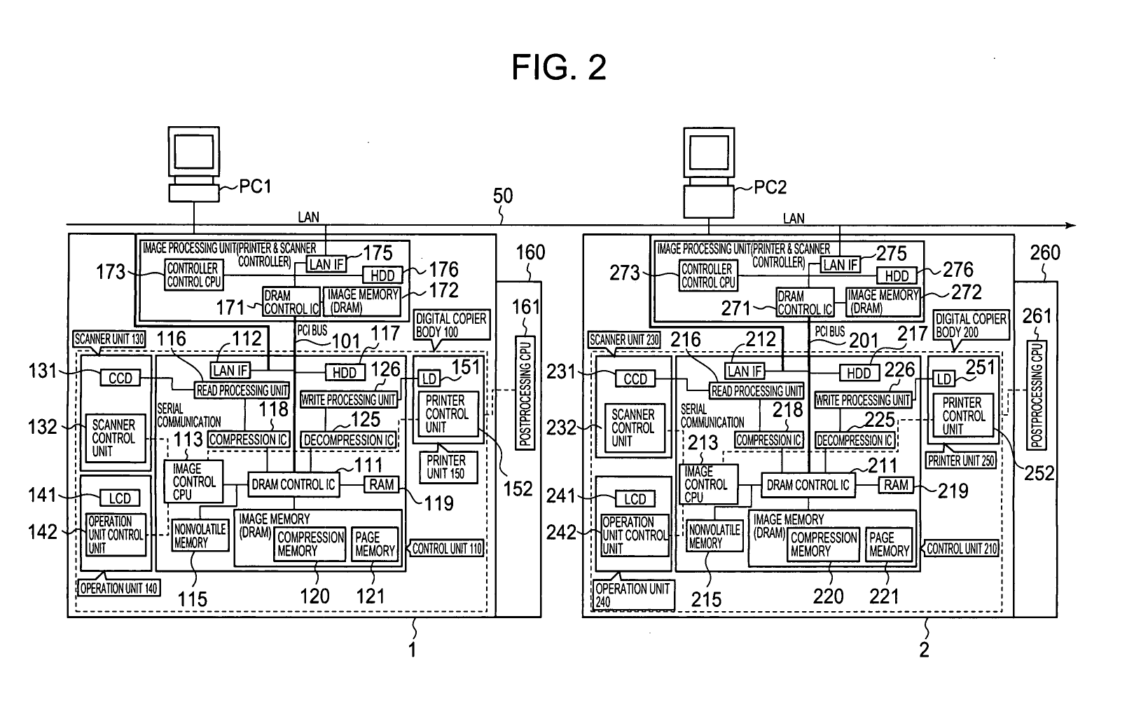

As shown in FIG. 2, the image printing apparatus 1 comprises a digital multifunctional machine, and another image printing apparatus 2 is connected to the image printing apparatus 1 through a LAN 50 so as to allow a tandem output operation, thereby forming a tandem image printing system. Although FIG. 2 shows the image printing apparatuses 1 and 2 as image printing apparatuses, the number of image printing apparatuses is not specifically limited in the present invention. Referring to FIG. 2, reference symbols PC1 and PC2 denote terminal apparatuses as external processing apparatuses. Note that the image printing apparatus 2 has also the same mechanical arrangement as that described above, and a description thereof will be omitted.

FIG. 2 shows the image printing apparatuses 1 and 2 as functional blocks. The details of these apparatuses will be described below.

As shown in the block diagram of FIG. 2, the image printing apparatuses 1 and 2 respectively comprise digital copier bodies 100 and 200 respectively including control units 110 and 210, scanner units 130 and 230, the operation unit 140 and an operation unit 240, and the printer unit 150 and a printer unit 250, and image processing units 170 and 270 which process image data input/output from/to the outside through the LAN 50.

The control units 110 and 210 of the digital copier bodies 100 and 200 respectively include LAN interfaces 112 and 212 connected to the LAN 50 as described above, and are connected to DRAM control ICs 111 and 211 through PCI buses 101 and 201 inside the image printing apparatuses 100 and 200. In addition, the control units 110 and 210 respectively comprise image control CPUs 113 and 213 which control the overall image printing apparatuses, and the DRAM control ICs 111 and 211 are connected to the image control CPUs 113 and 213.

Nonvolatile memories 115 and 215 are respectively connected to the image control CPUs 113 and 213. Programs for operating the image control CPUs 113 and 213, set data for the image printing apparatuses 1 and 2, and data such as process control parameters are stored in the nonvolatile memory 115. In addition, the specified value data of paper size information and paper type information can be stored in the nonvolatile memory 115, and data concerning the paper size information and paper type information of recording sheets in the paper feed unit can also be stored in the nonvolatile memory 115. The nonvolatile memories 115 and 215 function as recording sheet information registration units and paper feed/recording sheet information registration units in this embodiment.

RAMs 119 and 219 are respectively connected to the DRAM control ICs 111 and 211. The RAMs 119 and 219 serve as temporary storage of data and as work areas for programs. Large-capacity HDDs 117 and 217 are respectively connected to the DRAM control ICs 111 and 201 through the PCI buses 101 and 201. Image data can be stored in the HDDs 117 and 217. In addition, the above programs, set data, and the like can also be stored in these HDDs. When, therefore, the specified value data of paper size information and paper type information and data concerning the paper size information and paper type information of recording sheets in the paper feed units are to be stored in the HDDs 117 and 217, they function as the recording sheet information registration units and paper feed/recording sheet information registration units in this embodiment.

The image control CPUs 113 and 213 can read nonvolatile data from the nonvolatile memories 115 and 215, and can write desired data as nonvolatile data in the nonvolatile memories 115 and 215. The image control CPUs 113 and 213 can communicate with other image printing apparatuses and the like through the LAN 50 (pre-designated machines=IP addresses), and can transmit/receive image data, set parameters, and paper size information, paper type information to/from other image printing apparatuses. That is, the LAN interfaces 112 and 212 function as communication units in this embodiment. The image control CPUs 113 and 213 can exchange data with the nonvolatile memories 115 and 215, and can further exchange data with other image printing apparatuses through the LAN interfaces 112 and 212. Upon exchanging the above data, the image control CPUs 113 and 213 can determine a match/mismatch by comparing the paper size information and paper type information received through the LAN interfaces 112 and 212 with the paper size information and paper type information stored in the nonvolatile memories 115 and 215. The image control CPUs 113 and 213 therefore function as comparison and determination units in this embodiment.

When image information is to be output, the image control CPUs 113 and 213 can assign output operations to a plurality of image printing apparatuses and issue a tandem output instruction to each image printing apparatus. That is, a tandem output mode functions in accordance with the operations of the image control CPUs 113 and 213.

The scanner units 130 and 230 comprise CCDs 131 and 231 which perform optical reading and scanner control units 132 and 232 which perform overall control on the scanner units 130 and 230. The scanner control units 132 and 232 are connected to the image control CPUs 113 and 213 so as to allow serial communication. The CCDs 131 and 231 are also connected to read processing units 116 and 216 which process the image data read by the CCDs 131 and 231. Compression ICs 118 and 218 which compress image data are respectively connected to the read processing units 116 and 216. The compression ICs 118 and 218 are respectively connected to the DRAM control ICs 111 and 211 described above. Image reading units are respectively constituted by the scanner units 130 and 230, read processing units 116 and 216, compression ICs 118 and 218.

The operation units 140 and 240 respectively comprise LCD touch panels 141 and 241 as input units and operation unit control units 142 and 242. The LCD touch panels 141 and 241 are respectively connected to the operation unit control units 142 and 242, which are, in turn, respectively connected to the image control CPUs 113 and 213. The operation units 140 and 240 can display settings, input information such as operation commands, set contents, and the like in the image printing apparatuses 1 and 2. That is, the operation units 140 and 240 can input various kinds of settings, recording sheet information, changes, and recording sheet information in the paper feed units, and change such information. The operation units 140 and 240 therefore function as recording sheet information registration units, recording sheet information changing units, paper feed/recording sheet information registration units, paper feed/recording sheet information changing units, and paper feed setting units. The operation units 140 and 240 allow selection of paper feed trays, in the paper feed units, which can perform paper feeding operation. The operation units 140 and 240 therefore also function as paper feed tray selection input units.

The LCD touch panels 141 and 241 function as display units, which display necessary information and allow operators to recognize the information. Therefore, the LCD touch panels 141 and 241 also function as paper feed/recording sheet information selection units which register paper feed/recording sheet information while referring to registered recording sheet information.

Input results obtained by using the operation units 140 and 240 are output to the image control CPUs 113 and 213, and predetermined processing is then performed in accordance with the input contents. The image control CPUs 113 and 213 implement partial functions of the respective units in cooperation with the operation units 140 and 240.

The DRAM control ICs 111 and 211 are connected to image memories comprising compression memories 120 and 220 and page memories 121 and 221. Decompression ICs 125 and 225 which decompress compressed image data are respectively connected to the DRAM control ICs 111 and 211. Write processing units 126 and 226 are respectively connected to the LD (Laser Diode) 151 and an LD 251 of the printer units 150 and 250 to process data used for the operations of the LDs 151 and 251. The printer units 150 and 250 respectively comprise printer control units 152 and 252 which control the overall printer units 150 and 250. The printer control units 152 and 252 are respectively connected to the image control CPUs 113 and 213. Postprocessing CPUs 161 and 261 which control the postprocessing apparatus (FNS) 160 and a postprocessing apparatus 260 are respectively connected to the printer control units 152 and 252. The postprocessing apparatuses 160 and 260 are controlled through the printer control units 152 and 252.

DRAM control ICs 171 and 271 of the image processing units 170 and 270 are respectively connected to the DRAM control ICs 111 and 211 through the PCI buses 101 and 201. In the image processing control units 170 and 270, image memories 172 and 272 are respectively connected to the DRAM control ICs 171 and 271. In addition, in the image processing control units 170 and 270, the DRAM control ICs 171 and 271, controller control CPUs 173 and 273, and LAN interfaces 175 and 275 are connected to a common bus. The LAN interfaces 175 and 275 are connected to the LAN 50.

The basic operation of the above image printing operation will be described next.

A sequence of storing image data in the image printing apparatus 1 will be described first. Note that the image printing apparatuses 1 and 2 have the same arrangement as described above, and perform the same basic operation, and hence the following operation will be described with reference to the arrangement of the image printing apparatus 1.

A case wherein in the image printing apparatus 1, the scanner unit 130 reads an image to generate image data will be described first. Note that in image reading operation, a recording sheet to be output is set in advance. The details of this recording sheet setting will be described later.

In the scanner unit 130, the CCD 131 optically reads an image from a document. In this case, the operation of the CCD 131 is controlled by the scanner control unit 132 which receives a command from the image control CPU 113.

The image control CPU 113 operates in accordance with a program, and issues a command to the scanner unit 130 on the basis of operation by the operator using the operation unit 140 or the terminal apparatus PC1.

The image read by the CCD 131 is subjected to data processing by the read processing unit 116. The image data having undergone the data processing is compressed by the compression IC 118 using a predetermined method. The resultant data is then stored in the compression memory 120 through the DRAM control IC 111.

Image data can also be acquired externally. Such data is stored in the image memory 172 through the LAN 50 and the DRAM control IC 171. This data is received by the image processing unit 170 of the image printing apparatus 1 through the LAN interface 175, and is stored in the image memory 172 by the DRAM control IC 171. The data in the image memory 172 is sequentially sent to the compression IC 118 through the DRAM control IC 171, PCI bus 101, and DRAM control IC 111, and is compressed. The compressed data is stored in the compression memory 120 through the DRAM control IC 111.

In another case, image data is generated by, for example, image reading operation in the image printing apparatus 2 or the like, and is transmitted through the LAN 50. This data is received through the LAN interface 112 of the image printing apparatus 1, and is stored in the compression memory 120 through the DRAM control IC 111. In the tandem output operation, data is received by this sequence.

The image data stored in the compression memory 120 can be transmitted to another image printing apparatus 2 or the like through the DRAM control IC 111, LAN interface 112, and LAN 50. In another image printing apparatus 2 or the like, the image data can be received and stored, and image printing processing can also be performed with respect to the data. When image data is to be sent out to another image printing apparatus in the tandem output operation, the data is sent out through the LAN interface 112 by the same sequence as that described above.

When image output operation is to be performed by the image printing apparatus 1, i.e., the apparatus is to be used as a copying machine or printer, image data is stored in the compression memory 120 in the above manner, and the image data from the compression memory 120 is bitmapped in the page memory 121. The image data is then sent out to the decompression IC 125 through the DRAM control IC 111 to be decompressed. The decompressed data is sent out to the write processing unit 126. The LD 151 then writes the data on the photosensitive body. In addition, in the printer unit 150, upon receiving a command from the image control CPU 113, the printer control unit 152 controls the respective units. With the above operation, in the printer unit 150, an image is printed on a predetermined recording sheet (not shown), and the recording sheet is subjected to postprocessing in the postprocessing apparatus 160 under the control of the postprocessing CPU 161.

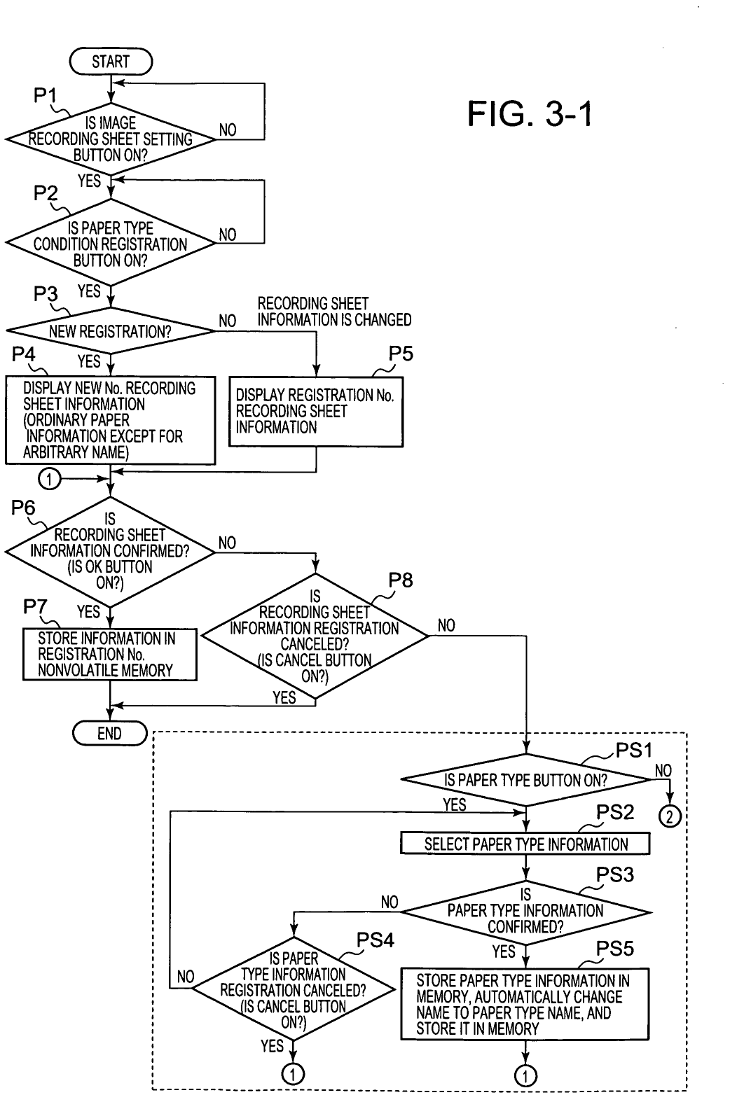

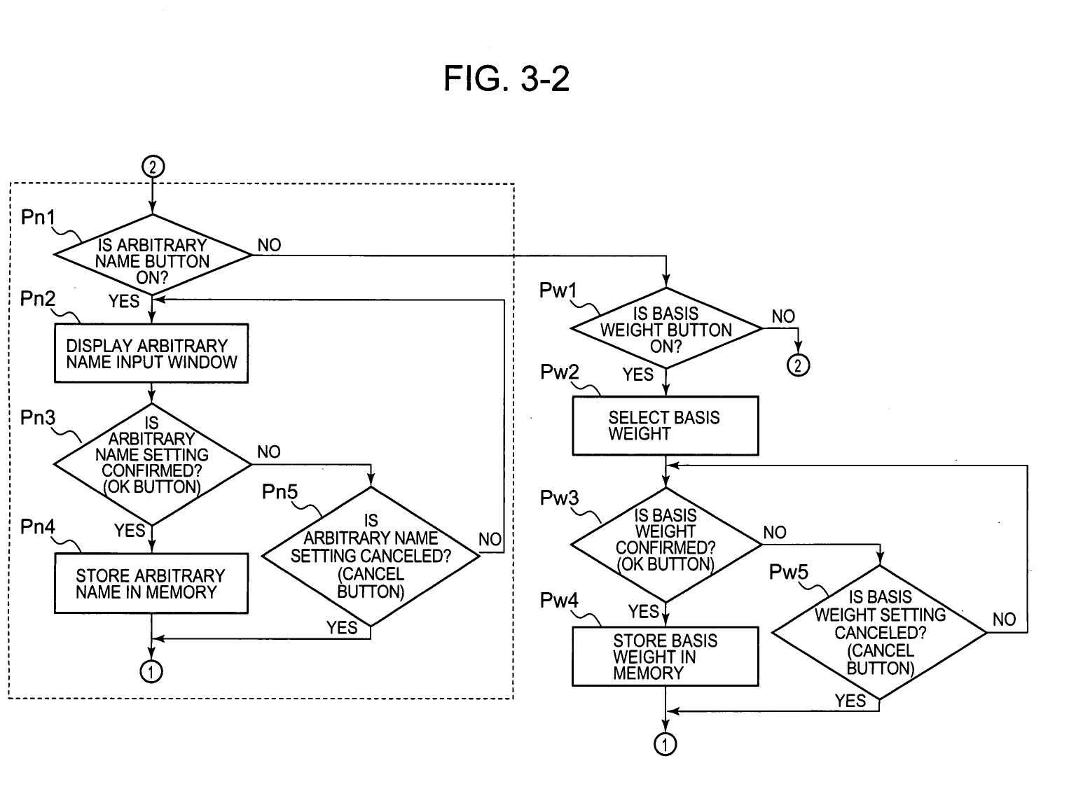

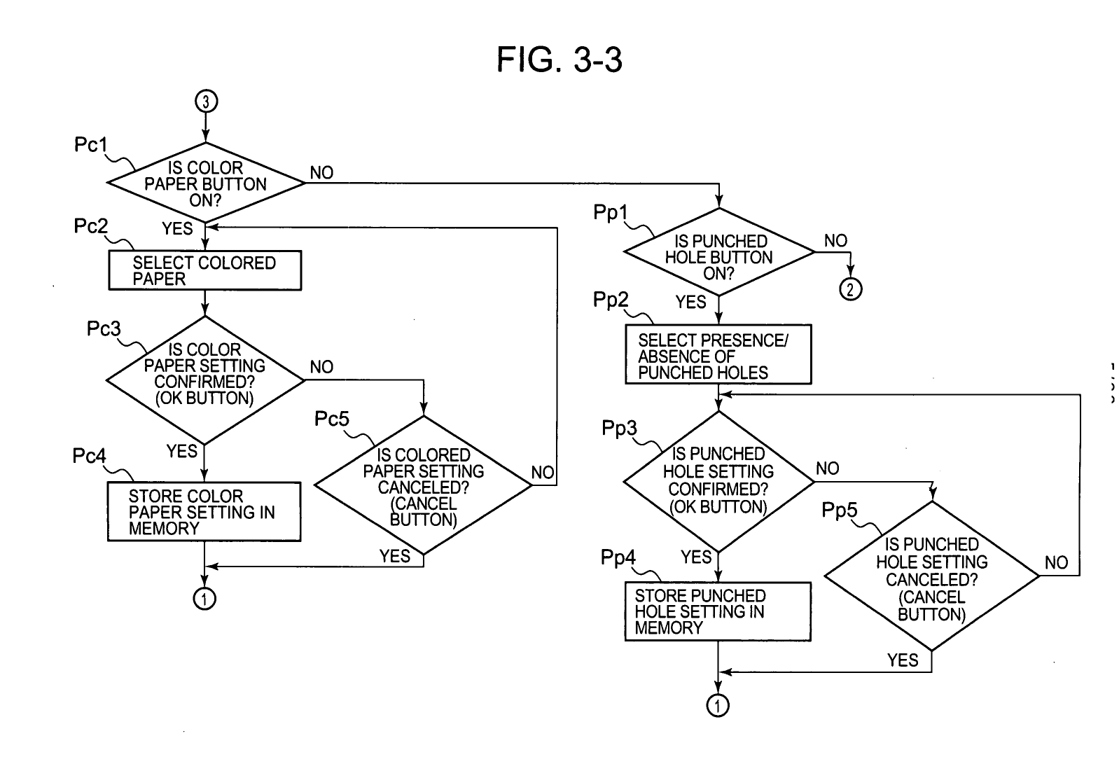

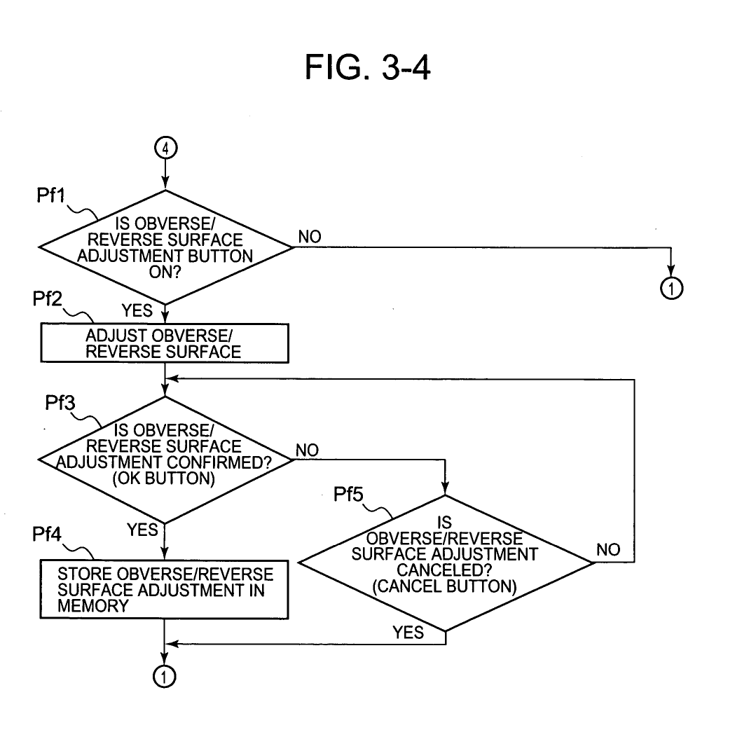

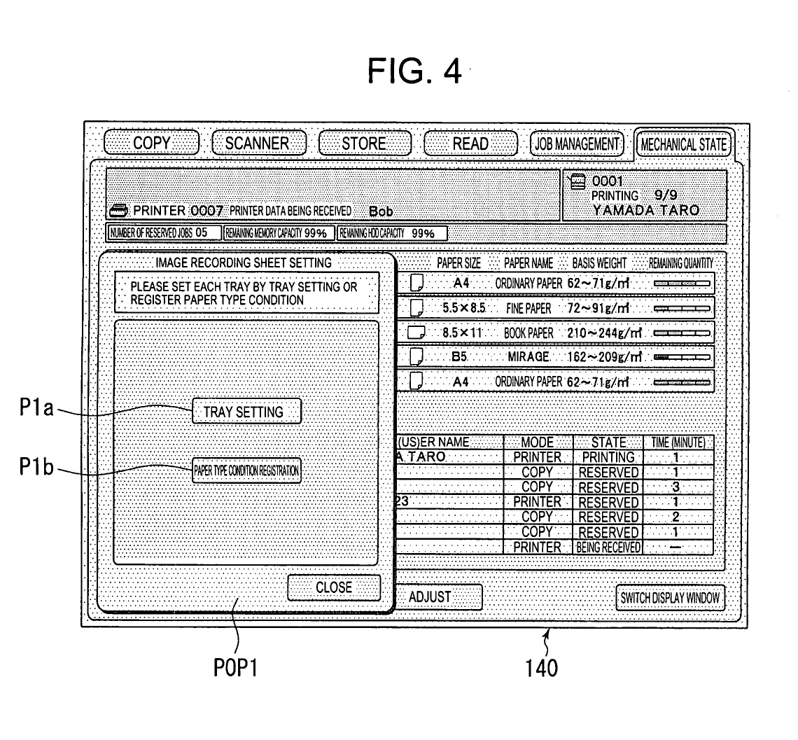

In the above operation of the image printing apparatus, recording sheet setting is performed. In the embodiment of the present invention, however, the settings associated with a recording sheet are registered in advance. Operation contents associated with this registration will be described below with reference to the flowcharts of FIGS. 3-1 to 3-4 and the operation windows shown in FIGS. 4 to 7.

First of all, if an image recording sheet is selected (step P1), a window P0P1 is displayed on the operation unit 140, as shown in FIG. 4. The window P0P1 can be displayed by, for example, operating an image recording sheet setting button provided on the mechanical state window displayed on the operation unit 140. A tray setting button P1a for setting a tray and a paper type information registration button P1b for registering the information of a recording sheet are displayed in the window P0P1.

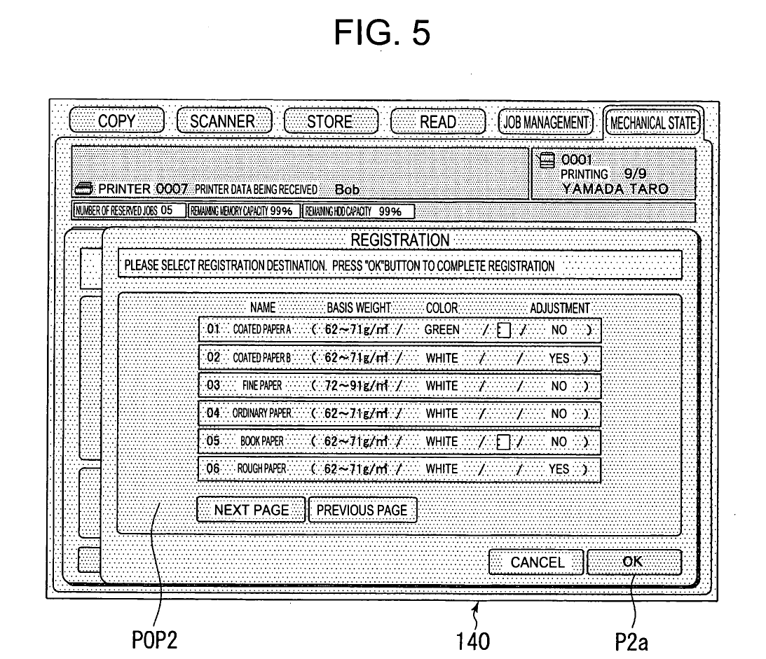

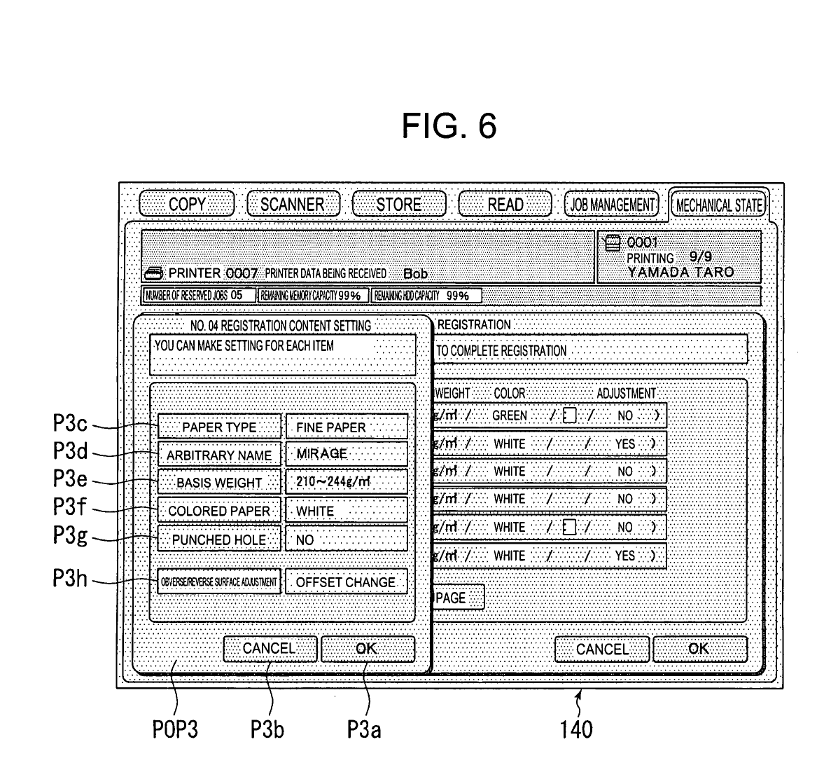

When the paper type information registration button P1b is turned on in this operation window (step P2), a list of registered paper type information is displayed in a window P0P2, as shown in FIG. 5. Paper type information in the embodiment of the present invention includes a basis weight, a color, the presence/absence of holes, and the like as well as a paper type presented as a name. When a paper type information item displayed in the window P0P2 is turned on in accordance with a registration No., paper type information corresponding to the registration No. is displayed in a window P0P3, as shown in FIG. 6, and a setting change is allowed (step P5). Although not shown in FIG. 5, new registration can be done by turning on a blanked registration No. item (step P3). In performing new registration, the contents of the respective items shown in FIG. 6 are blanked, and recording sheet information corresponding to the new No. is displayed (step P4). When an OK button P3a is turned on in the window P0P3, the registered contents are confirmed (step P6). When a registration destination is selected and an OK button P2a is turned on in the window P0P2, the registered contents are stored in the nonvolatile memory 115 (step P7). If a cancel button P3b is turned on in the window P0P3, the set contents are canceled, and the image recording sheet setting processing is terminated (step P8).

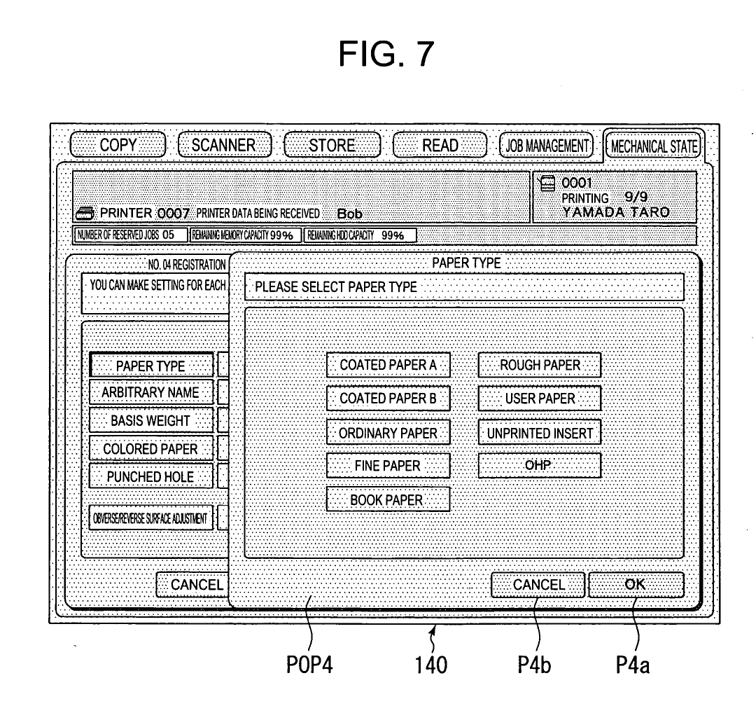

When an item column to be set is turned on in the window P0P3, the paper type information which has already been registered in the nonvolatile memory 115 in the above manner is displayed. If the operator presses a paper type button P3c without pressing the cancel button P3b (step P8 step PS1), paper types are displayed in a window P0P4 to allow selection (step PS2), as shown in FIG. 7. If the paper type button P3c is not pressed (step PS1), the flow advances to the step of determining whether an arbitrary name button P3d is pressed (step Pn1).

The paper types displayed in the window P0P4 can be registered in advance by initialization. The operator can select a paper type from those displayed in the window. When a proper paper type button is pressed and an OK button P4a is turned on, paper type information is confirmed (step PS3) and is stored in the RAM (memory) 119. In addition, the name is automatically changed to the paper type name, which is stored in the RAM 119 in the same manner as described above (step PS5). If a cancel button P4b is turned on in the window P0P4, the setting is canceled, and the image recording sheet setting processing is terminated (step PS4). After steps PS4 and PS5, the flow shifts to step P6 described above.

If the arbitrary name button P3d is pressed (step Pn1), a window (not shown) which allows the operator to input an arbitrary name is displayed on the operation unit 140 (step Pn2). If the arbitrary name button P3d is not pressed (step Pn1), the flow advances to the step of determining whether a basis weight button P3e is pressed (step Pw1). If the OK button is turned on in the window for inputting an arbitrary name, an arbitrary name content is confirmed (step Pn3), and the set content is stored in the RAM 119 (step Pn4). If the cancel button is turned on in the window for inputting an arbitrary name, the setting is canceled, and the arbitrary name setting processing is terminated (step Pn5). After steps Pn4 and Pn5, the flow shifts to step P6 described above.

If the basis weight button P3e is pressed (step Pw1), a window (not shown) for the selection of a basis weight is displayed on the operation unit 140 (step Pw2). The basis weights displayed in this window can be registered in advance by initialization, or the window may allow the operator to input an arbitrary value. If the basis weight button P3e is not pressed (step Pw1), the flow advances to the step of determining whether a colored paper button P3f is pressed (step Pc1). If the OK button is turned on in the basis weight selection window, a basis weight is confirmed (step Pw3), and the set content is stored in the RAM 119 (step Pw4). If the cancel button is turned on in the basis weight selection window, the setting is canceled, and the basis weight selection processing is terminated (step Pw5). After steps Pw4 and Pw5, the flow shifts to step P6 described above.

If the colored paper button P3f is pressed (step Pc1), a window (not shown) for selecting colored paper is displayed on the operation unit 140 to allow selection (step Pc2). The colored paper displayed in this window can be registered in advance by initialization. If the colored paper button P3f is not pressed (step Pc1), the flow advances to the step of determining whether a punched hole button P3g is pressed (step Pp1). If the OK button is turned on in the window for selecting colored paper, the colored paper setting is confirmed (step Pc3), and the set content is stored in the RAM 119 (step Pc4). If the cancel button is turned on in the window for selecting colored paper, the setting is canceled, and the colored paper selection processing is terminated (step Pc5). After steps Pc4 and Pc5, the flow shifts to step P6 described above.

If the punched hole button P3g is pressed (step Pp1), a window (not shown) for selecting the presence/absence of punched holes is displayed on the operation unit 140 (step Pp2). If the punched hole button P3g is not pressed (step Pp1), the flow advances to the step (step Pf1) of determining whether an obverse/reverse surface adjustment button P3h is pressed (step Pf1). If the OK button is turned on in the window for selecting the presence/absence of punched holes, the punched hole setting is confirmed (step Pp3), and the set content is stored in the RAM 119 (step Pp4). If the cancel button is turned on in the window for selecting the presence/absence of punched holes, the setting is canceled, and the processing of selecting the presence/absence of punched holes is terminated (step Pp5). After steps Pp4 and Pp5, the flow shifts to step P6 described above.

If the obverse/reverse surface adjustment button P3h is pressed (step Pf1), a window (not shown) for adjusting the offsets of an image position and magnification for each obverse/reverse surface is displayed on the operation unit 140 to allow obverse/reverse surface adjustment (step Pf2). Note that if the obverse/reverse surface adjustment button P3h is not pressed (step Pf1), the flow shifts to step P6. If the OK button is turned on in the obverse/reverse surface adjustment window, obverse/reverse surface adjustment is confirmed (step Pf3), and the set content is stored in the RAM 119 (step Pf4). If the cancel button is turned on in the obverse/reverse surface adjustment window, the setting is canceled, and the obverse/reverse surface adjustment processing is terminated (step Pf5). After steps Pf4 and Pf5, the flow shifts to step P6 described above.

When the set contents of recording sheets are stored in the RAM 119 and the setting is terminated by the above sequence, the window P0P3 shown in FIG. 6 is displayed. If the OK button P3a is turned on this window, all the settings are confirmed (step P6). If the cancel button P3b is turned on, all the setting contents are canceled. After these operations, the window P0P2 shown in FIG. 5 is displayed. When a registration destination is selected from the displayed registration Nos., and the OK button P2a is turned on, the set content temporarily stored in the RAM 119 is registered in the nonvolatile memory 115. The set content registered in the nonvolatile memory 115 can be read out through the image control CPU 113, as needed.

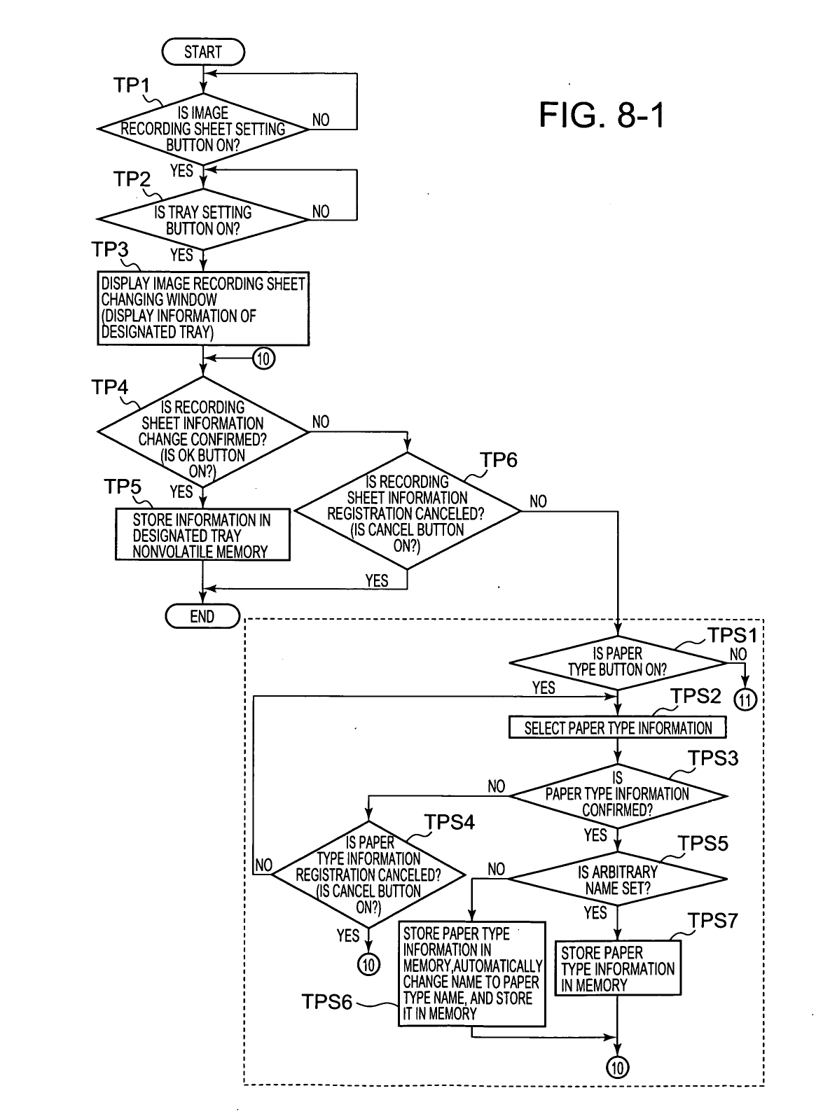

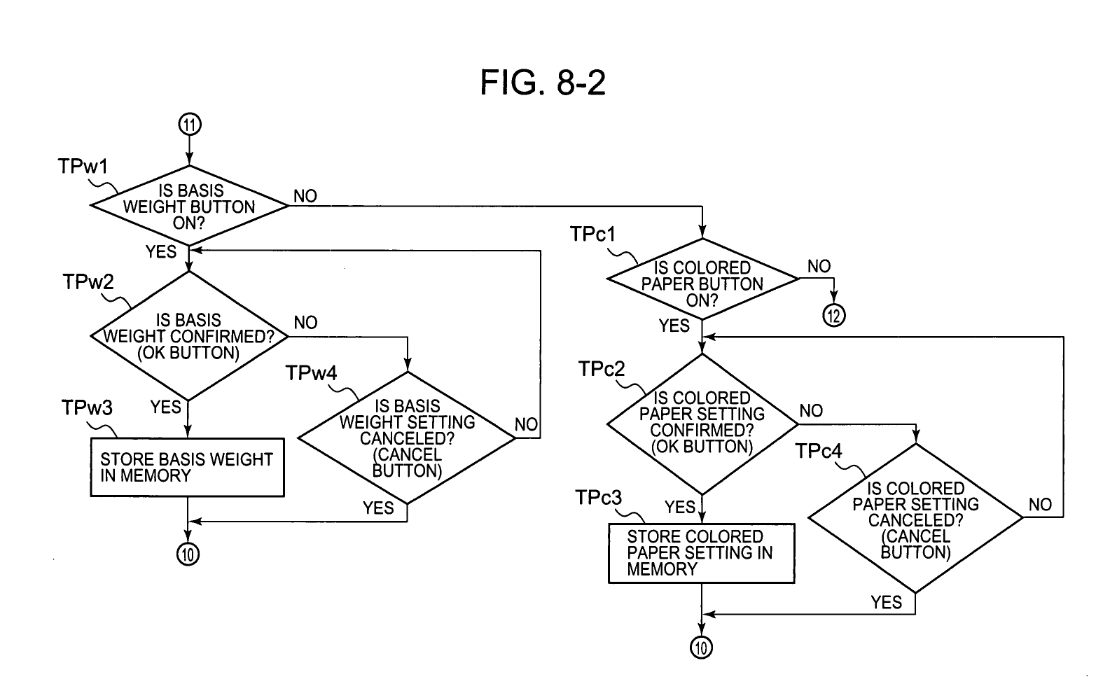

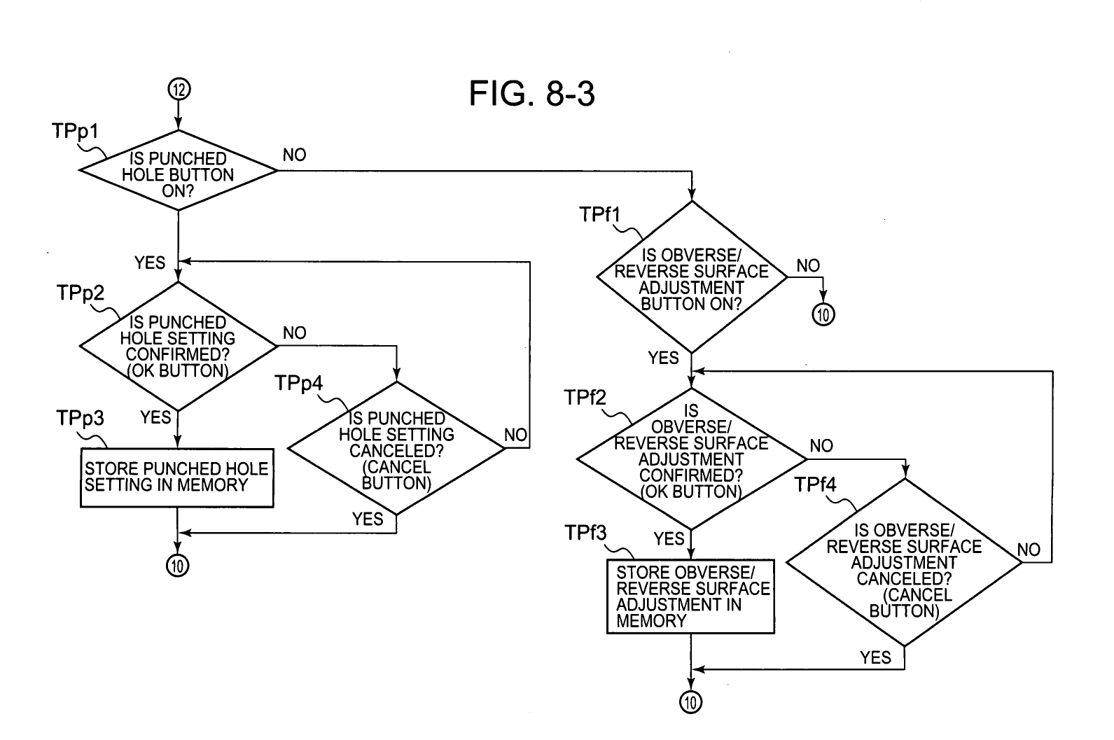

A sequence of registering paper feed/recording sheet information for each paper feed tray will be described next with reference to the flowcharts of FIGS. 8-1 to 8-3.

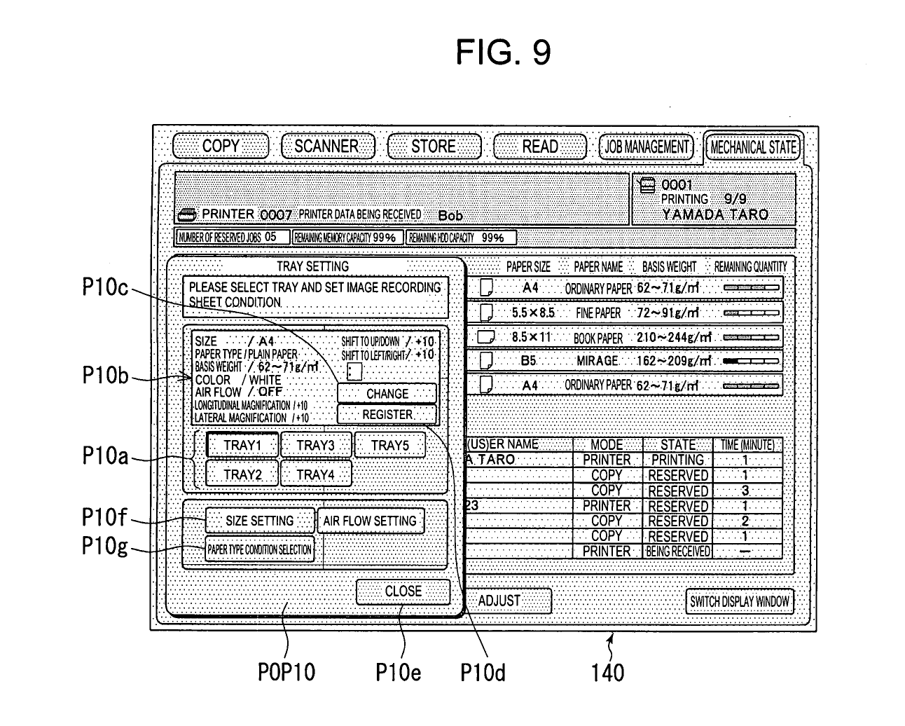

First of all, if the image recording sheet setting button is selected (step TP1), the window P0P1 is displayed on the operation unit 140, as shown in FIG. 4. If the tray setting button P1a for performing tray setting is pressed in the window P0P1 (step TP2), a tray selection button P10a, a recording sheet information column P10b for the selected tray, a change button P10c, a registration button P10d, a close button P10e, a size setting button P10f, a paper type condition selection button P10g, and the like are displayed in a window P0P10, as shown in FIG. 9, to allow the operator to register and change recording sheet information for the tray (step TP3). When the displayed tray selection button P10a is selected and turned on in the window P0P10, the designated tray is changed, and the displayed contents in the recording sheet information column P10b of the tray are changed to the contents for the designated tray.

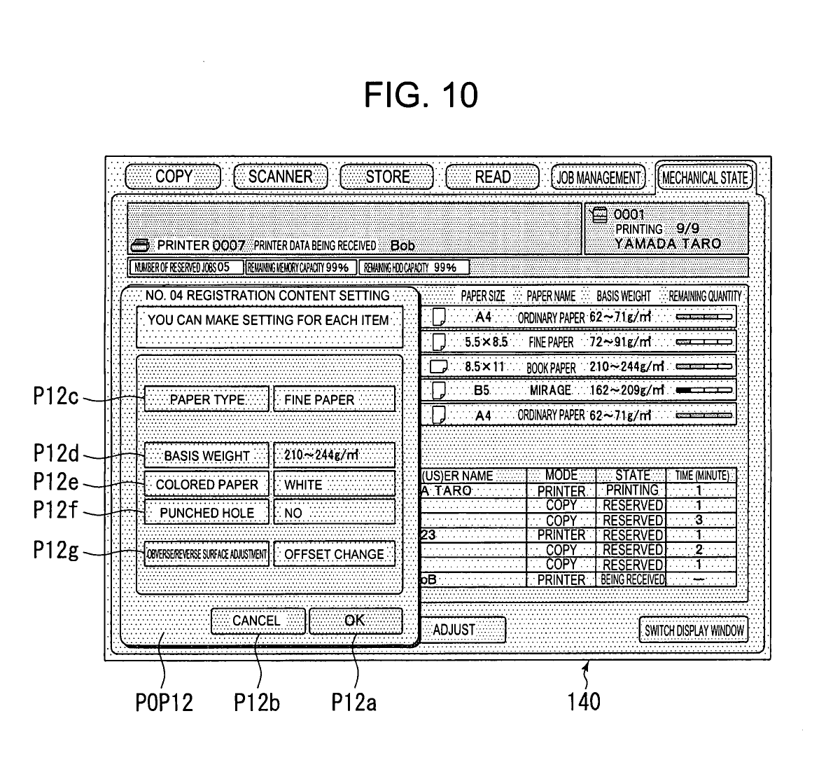

When the change button P10c is pressed in the window P0P10, a window P0P12 shown in FIG. 10 is displayed to allow setting of items of paper type, basis weight, colored paper, presence/absence of punched holes, and obverse/reverse surface adjustment concerning a recording sheet by the sequences shown in FIGS. 8-1 to 8-3.

If a paper type button P12c is pressed (step TPS1), a paper type can be selected (step TPS2). Note that if the paper type button P12c is not pressed, the flow advances to the step of determining whether a basis weight button P12d is pressed (step TPw1).

When paper type information is confirmed (step TPS3) and there is an arbitrary name (step TPS5), the set content is stored in the RAM 119 (step TPS7). If there is no arbitrary name, the paper type name is automatically set to the arbitrary name, and the set contents including the name are stored in the RAM 119 (step TPS6). If no paper type is confirmed, paper type selection is continued until the cancel button is pressed (step TPS4). If the cancel button is pressed, the flow shifts to step TP4. After steps TSP6 and TSP7, the flow shifts to step TP4 described above.

If the basis weight button P12d is pressed (step TPw1), a basis weight can be set. Note that if the basis weight button P12d is not pressed, the flow advances to the step of determining whether a colored paper button P12e is pressed (step TPc1). If a basis weight is confirmed by basis weight setting (step TPw2), the registered content is stored in the RAM 119 (step TPw3). If no basis weight is confirmed, and the setting is canceled by turning on the cancel button, the basis weight setting processing is terminated (step Pw4). If cancellation is not performed, basis weight setting is continued. After the basis weight setting processing is terminated, the flow shifts to step TP4 described above.

If the colored paper button P12e is pressed (step TPc1), colored paper setting can be done. If the colored paper button P12e is not pressed, the flow shifts to the step of determining whether a punched hole button P12f is pressed (step TPp1). If colored paper is confirmed by colored paper setting (step TPc2), the set content is stored in the RAM 119 (step TPc3). If no colored paper is confirmed and the setting is canceled by turning on the cancel button, the colored paper setting processing is terminated, and the flow shifts to step TP4. If no cancellation is performed, colored paper setting is continued. After the colored paper setting processing, the flow shifts to step TP4 described above.

If the punched hole button P12f is pressed (step TPp1), the presence/absence of punched holes can be selected. If the punched hole button P12f is not pressed (step TPp1), the flow advances to the step of determining whether an obverse/reverse surface adjustment button P12g is pressed (step TPf1). If punched hole setting is confirmed (step TPp2), the set content is stored in the RAM 119 (step TPp3). If the presence/absence of punched holes is not confirmed and the setting is canceled by turning on the cancel button, the punched hole setting processing is terminated, and the flow shifts to step TP4. If no cancellation is performed, punched hole setting is continued. After the punched hole setting processing, the flow shifts to step TP4 described above.

If the obverse/reverse surface adjustment button P12g is pressed (step TPf1), the offsets of an image position and magnification for each obverse/reverse surface can be adjusted. Note that if the obverse/reverse surface adjustment button P12g is not pressed (step TPf1), the flow shifts to step TP4 described above. If obverse/reverse surface adjustment is confirmed (step TPf2), the set content is stored in the RAM 119 (step TPf3). If no obverse/reverse surface adjustment is confirmed and the setting is canceled by turning of the cancel button, the obverse/reverse surface adjustment processing is terminated, and the flow shifts to step TP4. If no cancellation is performed, the obverse/reverse surface adjustment setting is continued. If the obverse/reverse surface adjustment processing is terminated, the flow shifts to step TP4.

With the above sequence, when recording sheet information in the tray is set and an OK button P12a is turned on, all the settings are confirmed, and the set contents temporarily stored in the RAM 119 are registered in the nonvolatile memory 115. If a cancel button P12b is turned on, all the changed set contents are canceled. The set contents registered in the nonvolatile memory 115 can be read out through the image control CPU 113, as needed. When the apparatus has a plurality of trays, the same processing as described above can be performed for each tray.

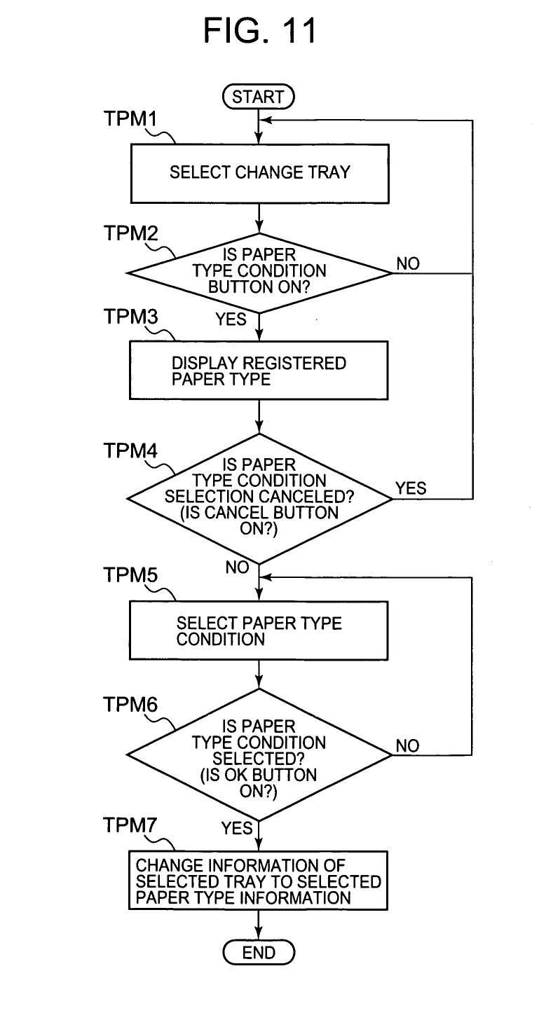

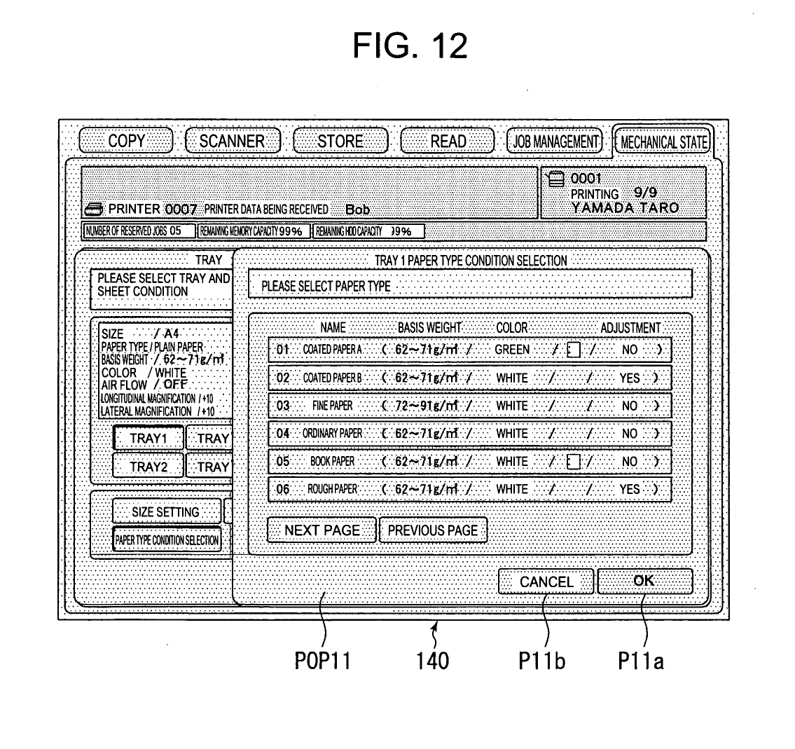

When the size setting button P10f is turned on in the window P0P10, the size of a recording sheet on the tray selected with the tray selection button P10a can be set. In addition, in the window P0P10, the paper feed/recording sheet information concerning the tray can be changed by using the pre-registered recording sheet information. This sequence will be described with reference to the flowchart of FIG. 11 and the operation window shown in FIG. 12.

After a changed tray is selected by operating the tray selection button P10a (step TPM1), the paper type condition selection button P10g is turned on (step TPM2) to call up the registered recording sheet information from the nonvolatile memory 115. As shown in FIG. 12, a list of recording sheet information is displayed in a window P0P11 on the operation unit 140 (step TPM3).

If a cancel button P11b is pressed in this list (step TPM4), the window P0P10 is restored. If one of the items in the list is turned on, the corresponding paper type condition is selected (step TPM5). If an OK button P11a is further pressed (step TPM6), the recording sheet information of the tray is changed to the selected paper type condition content (step TMP7), and the processing is terminated. The changed recording sheet information is displayed in the recording sheet information column P10b corresponding to the tray.

When the recording sheet information of the tray is changed in the above manner, the corresponding content can be registered as pre-registered recording sheet information. This processing is started when the registration button P10d is turned on in the window P0P12. When the registration button P10d is turned on, the window P0P2 is displayed as in the case shown in FIG. 5 described above. When a registration destination is selected from the displayed registration Nos. and the OK button P2a is turned on in the window P0P2, the paper type setting content corresponding to the tray is registered as recording sheet information corresponding D to the registration No. in the nonvolatile memory 115. Note that a new registration destination can be registered by selecting a blanked registration destination. The registered content can be read out through the image control CPU 113, as needed.

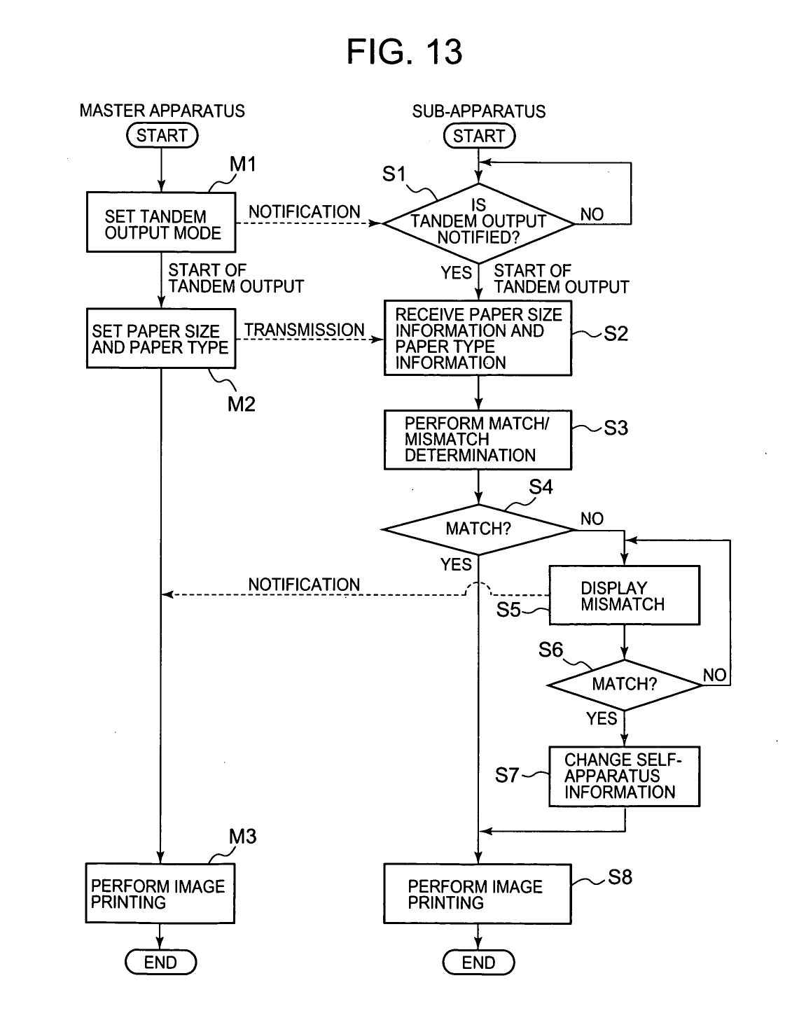

A basic sequence of performing the tandem output operation between image printing apparatuses in which recording sheet information and paper feed/recording sheet information are registered by the above operation will be described with reference to FIG. 13. The following description will be made on the assumption that the image printing apparatus 2 serves as a master apparatus, and the image printing apparatus 1 serves as a sub-apparatus.

When tandem setting is performed in the image printing apparatus 2 as a master apparatus by turning on a tandem button or the like, the apparatus is set in the tandem output mode. The corresponding information is transmitted (notified) through the LAN interface 212 and the LAN 50 by the operation of the image control CPU 213 (step M1). In the image printing apparatus 1, data has been input through the LAN interface 112 by the operation of the image control CPU 113. This apparatus shifts to the tandem output mode upon receiving the above notification (step S1).

In the image printing apparatus 2 as the master apparatus, conditions for recording sheets for which the tandem output operation is to be performed are set from set recording sheet information (step M2). The settings include paper size information and paper type information. This setting can be generally performed by selecting paper feed/recording sheet information concerning the paper feed tray provided for the image printing apparatus 2. The set sheet size information and paper type information are transmitted from the image printing apparatus 2 to the image printing apparatus 1 as a sub-apparatus through the LAN 50, together with the image data, in the same manner as described above. Subsequently, the image printing apparatus 2 can perform image printing in accordance with the tandem output operation. The above information transmitted from the image printing apparatus 2 is received by the image printing apparatus 1 as a sub-apparatus (step S2) and is stored in the HDD 117 or the like. In the image printing apparatus 1, information of recording sheets which can be fed from the first to third paper feed trays 153 and the large-capacity paper feed tray 154 is read out from the nonvolatile memory 115, and is compared with the received information, thereby determining a match/mismatch (step S3). A detailed sequence for determination will be described later. If the received paper size information and paper type information match the paper size information and paper type information of recording sheets which can be fed (step S4), image printing is performed in the image printing apparatus 1 (step S8).

If the received paper size information and paper type information do not match the paper size information and paper type information of recording sheets which can be fed in the image printing apparatus 1 as a sub-apparatus, information indicating a mismatch is displayed on the operation unit 140, and image printing is stopped. In this case, the image printing apparatus 1 can notify the image printing apparatus 2 of information indicating the mismatch through the LAN 50 to make the image printing apparatus 2 as the master apparatus to display a mismatch indication.

Upon seeing the above mismatch indication in the image printing apparatus 1, the operator can set matched recording sheets on a tray in the image printing apparatus 1. When the received paper size information and paper type information match the paper size information and paper type information of recording sheets which can be fed, the image printing apparatus 1 changes and registers paper feed/recording sheet information in accordance with the changed recording sheets. With this operation, the image printing apparatus 1 performs image printing by the tandem output operation, thereby performing the tandem output operation on the basis of similar output results from the image printing apparatuses 1 and 2. Note that the image printing apparatus 1 can also perform image printing in parallel with or independently of changing/registration of paper feed/recording sheet information.

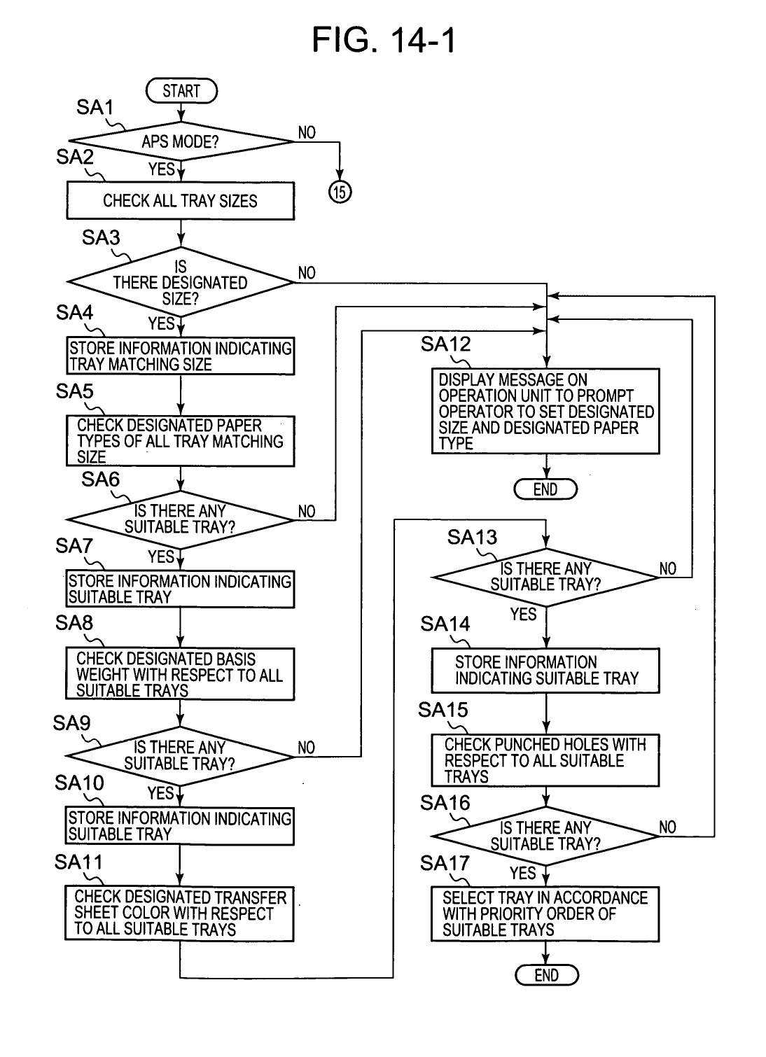

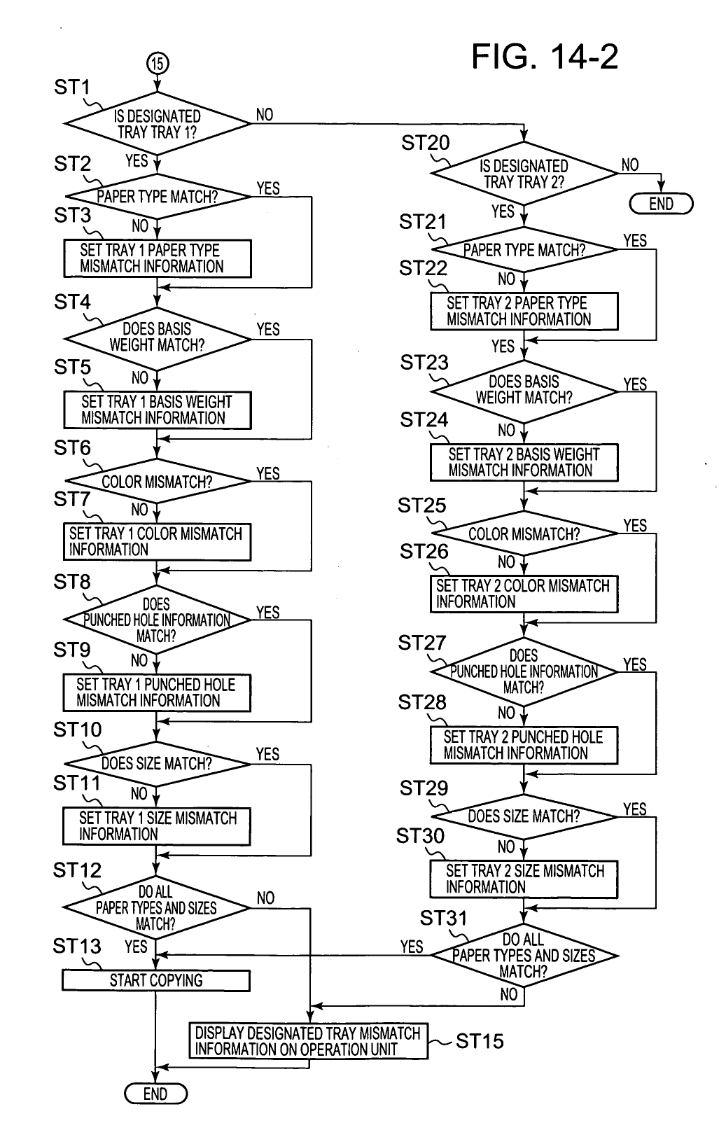

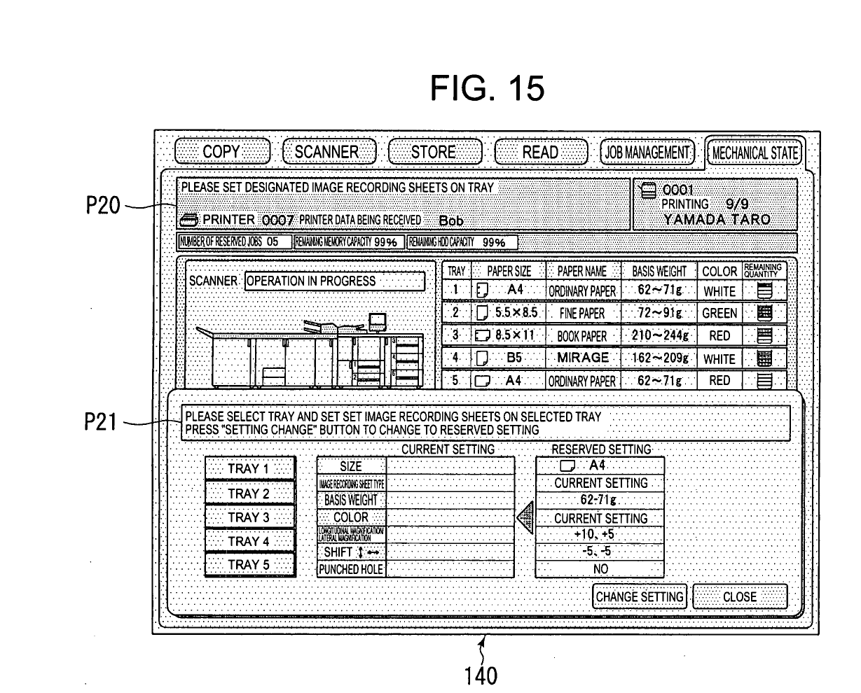

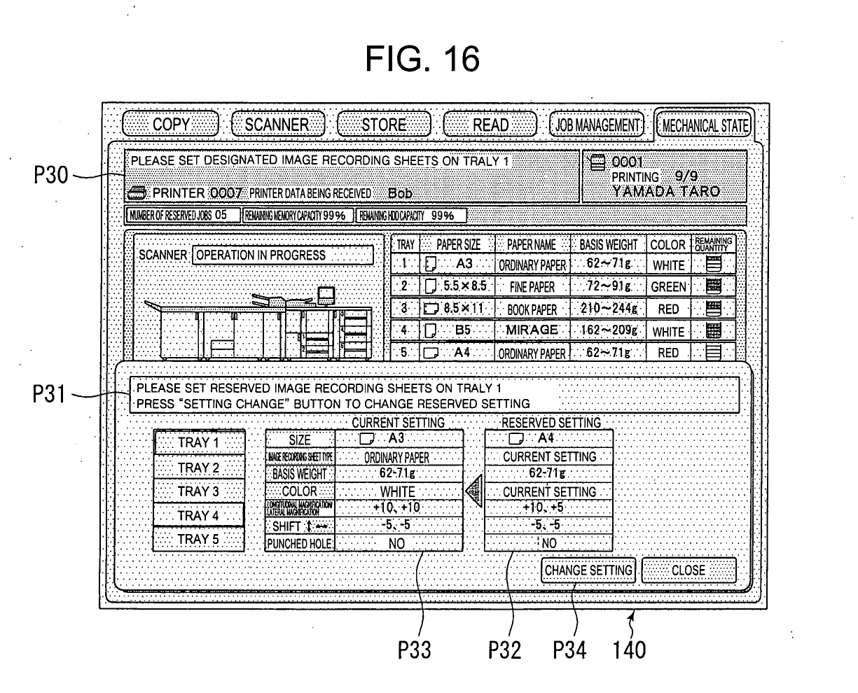

Detailed sequences of determining matches/mismatches between the paper size information and paper type information received by the image printing apparatus 1 and the paper size information and paper type information of recording sheets which can be fed will be described with reference to the flowcharts of FIGS. 14-1 and 14-2 and the operation windows shown in FIGS. 15 and 16.

First of all, it is determined whether the sub-apparatus is set in the APS (Automatic Paper Selection) mode (step SA1). If a fixed tray is used, the flow shifts to step ST1 to perform determination with respect to the fixed tray.

In the APS mode, the sizes of recording sheets on all the trays are checked on the basis of paper feed/recording sheet information (step SA2). It is then determined whether any recording sheet matches the received paper size information, i.e., the designated size (step SA3). If there are recording sheets which match the designated size, information indicating the tray matching the size is stored (step SA4). This information can be stored in a memory or the like. If the recording sheets on all the trays do not match the designated size, a mismatch indication P20 is displayed on the operation unit 140 as shown in FIG. 15 to prompt the operator to set recording sheets matching the designated paper size and designated paper type. Image printing operation is not started, and the apparatus is set in the standby state. A setting change request indication P21 is further displayed to prompt the operator to change and register the paper feed/recording sheet information of the tray selected by the operator so as to reliably perform setting after setting recording sheets matching the designated paper size and paper type on the tray (step SA12). At this time, the image printing apparatus 2 as the master apparatus can display a mismatch indication similar to the indication P20. Note that if there are a plurality of sub-apparatuses, it suffices to also display information indicating any image printing apparatus in which a mismatch has occurred. Upon seeing this information, the operator can go to the sub-apparatus corresponding to the displayed information and set necessary image recording sheets.

If there is a tray having recording sheets matching the designated size, the paper type of recording sheets on the tray matching the designated size is checked (step SA5). It is then determined on the basis of the received paper type information whether there are recording sheets matching the designated paper type (step SA6). If there are recording sheets matching the designated paper type, information indicating the tray matching the designated paper type is stored (step SA7). This information is stored in the memory or the like as in the above case. Note that if the checked tray has no recording sheets matching the designated paper type, step SA12 described above is executed.

If there is a tray having recording sheets matching the designated paper type, the basis weight of each recording sheet on the tray matching the designated paper type is checked (step SA8). It is determined on the basis of the received paper type information whether there is any tray matching the designated basis weight (step SA9). If there are recording sheets matching the designated basis weight, information indicating the tray having the recording sheets matching the designated basis weight is stored (step SA10). This information is stored in the memory or the like. Note that if the checked tray has no recording sheets matching the designated basis weight, step SA12 described above is executed.

If there is a tray having recording sheets matching the designated basis weight, the paper color of the recording sheets on the tray matching the designated basis weight is checked (step SA11). It is then determined on the basis of the received paper type information whether there are recording sheets matching the designated the designated paper color (step SA13). If there are recording sheets matching the designated paper color, information indicating the tray having the recording sheets matching the designated paper color is stored (step SA14). This information is stored in the memory or the like. Note that if the checked tray has no recording sheets matching the designated paper color, step SA12 described above is executed.

If there is a tray having the recording sheets matching the designated paper color, the presence/absence of punched holes of recording sheets on the tray matching the designated paper color is checked (step SA15). It is then determined on the basis of the received paper type information whether there are recording sheets matching designated information concerning the presence/absence of punched holes (step SA16). If there are recording sheets matching the designated information concerning the presence/absence of punched holes, information indicating the tray having the recording sheets is stored in order of priority (step SA17).

In the above sequence, if a tray matching the paper size condition and paper type condition is recognized, image printing is performed in order of priority.

When a fixed tray is to be used, it is determined whether the designated tray is tray 1 (step ST1). If the designated tray is not tray 1, it is determined whether the designated tray is tray 2 (step ST20). If there are three or more trays, it is determined, in the same manner as described above, whether the designated tray is tray 3 and so on.

If the designated tray is tray 1, it is determined whether the paper type of tray 1 matches the designated paper type (step ST2). If the paper types do not match each other, paper type mismatch information concerning tray 1 is stored in the memory or the like (step ST3). If the paper types match each other, it is determined after step ST3 whether the basis weight of the recording sheets on tray 1 matches the designated basis weight (step ST4). If the paper types do not match each other, this determination is performed after step ST3. If the basis weights do not match each other, basis weight mismatch information concerning tray 1 is stored in the memory or the like (step ST5). If the basis weights match each other, it is determined after step ST4 whether the color of the recording sheets on tray 1 matches the designated color (step ST6). If the basis weights do not match each other, this determined is performed after step ST5. In this case, if the paper colors do not match each other, paper color mismatch information concerning tray 1 is stored in the memory or the like (step ST7) If the paper colors match each other, it is determined after step ST6 whether the presence/absence of the punched holes of the recording sheets on tray 1 matches the designated presence/absence information (step ST8). If the paper colors do not match each other, this determination is performed after step ST7. If the presence/absence of punched holes does not match the designated presence/absence information, punched hole presence/absence mismatch information concerning tray 1 is stored in the memory or the like (step ST9). If the presence/absence of punched holes matches the designated presence/absence information, it is determined after step ST8 whether the size of the recording sheets on tray 1 matches the designated size (step ST10). If the presence/absence of punched holes does not match the designated presence/absence information, this determination is performed after step ST9. If the paper sizes do not match each other, paper size mismatch information concerning tray 1 is stored in the memory or the like (step ST1). If the paper sizes match each other, it is determined after step ST10, while referring to the above mismatch registrations, whether both the paper size and paper type of the recording sheets on tray 1 match designated paper size and paper type. If the paper sizes do not match each other, this determination is performed after step ST11. If both the paper size and paper type match the designated paper size and paper type, image printing (copying) on a recording sheet fed from tray 1 is started. If the paper size or paper type of the recording sheets does not match the designated one, a mismatch indication P30 is displayed on the operation unit 140, as shown in FIG. 16, to prompt the operator to change the recording sheets. In addition, a reserved information column P32 indicating the information of the designated recording sheet and set recording sheet information column P33 indicating the information of the recording sheets on the selected tray are displayed on the operation unit 140. In this case, the information of the recording sheet indicated in the reserved information column P32 and the information indicated in the set recording sheet information column P33 are displayed such that any mismatch therebetween can be discriminated by being displayed in a different color or the like. This makes it possible for the operator to quickly recognize the contents of mismatches. In order to cope with a case wherein the recording sheets are changed, the operation unit 140 is provided with a setting change request column P31 for prompting the operator to change the paper feed/recording sheet information. If a mismatch is displayed, the operator replaces the recording sheets stored in the designated paper feed tray with other recording sheets in accordance with the reserved set contents, thereby storing, in the designated paper feed tray, recording sheets matching the reserved setting contents. When a setting change button P34 is turned on afterward, the paper feed/recording sheet information of the tray is quickly changed to the reserve recording sheet information, thus facilitating the operation of changing settings. Subsequently, the tandem output operation can be performed by feeding recording sheets whose size and paper type match the reserved setting contents. Note that the above embodiment has exemplified the determination before the start of image printing. However, similar determination can be performed if no matched recording sheet is left after image printing operation is temporarily started. This makes it possible to perform similar mismatch display and stop image printing.

Although the present invention has been described on the basis of the above embodiment, the present invention is not limited to the above contents and can be changed within the range of the present invention.

The present invention has the following subsidiary aspects in addition to the above three main aspects.

According to the first subsidiary aspect of the present invention, in the image printing apparatus described in the first main aspect, the mismatch notification unit is a display unit which displays a mismatch indication. This makes it possible to display a mismatch notification on the display unit and easily notify the operator of the corresponding information.

According to the second subsidiary aspect of the present invention, in the image printing apparatus described in the first subsidiary aspect described above, the display unit displays information requesting to obtain recording sheets matching a designated paper size and paper type. Since this prompts a change to recording sheets exhibiting a paper size match and a paper type match, the tandem output operation of obtaining identical print results can be reliably performed.

According to the third subsidiary aspect of the present invention, in the image printing apparatus described in the first or second subsidiary aspect described above, the display unit discriminatively displays at least the content of a mismatch. With this operation, the content of a mismatch is discriminatively displayed, and the content of the mismatch can be easily understood. Therefore, subsequent operation, i.e., a change to matched recording sheets or the like, is facilitated.

According to the fourth subsidiary aspect of the present invention, the image printing apparatus described in any one of the first main aspect and the first to third subsidiary aspects further comprises a recording sheet information registration unit in which the specified values of the paper size information and paper type information of a plurality of recording sheets are set and registered in advance. This makes it possible to register the paper size information and paper type information of recording sheets in advance. Since paper sizes and paper types are expressed by these registered specified values, the types of recording sheets are standardized and can be easily comprehended. Note that paper size information and paper type information can be registered by being stored as data in a nonvolatile memory, HDD, or the like incorporated in the image printing apparatus.

According to the fifth subsidiary aspect of the present invention, the image printing apparatus described in the fourth subsidiary aspect described above further comprises a recording sheet information changing unit which changes the registered specified values of the paper size information and paper type information of recording sheets. This makes it possible to change the registrations of paper size information and paper type information.

According to the sixth subsidiary aspect of the present invention, the image printing apparatus described in any one of the first main aspect and the first to fifth subsidiary aspects described above further comprises a paper feed/recording sheet information registration unit which sets and registers the paper size information and paper type information of recording sheets in the paper feed unit. This makes it possible to set and register the paper size information and paper type information of recording sheets in the paper feed unit. This registration makes it possible to quickly obtain the information of recording sheets which can be fed.

According to the seventh subsidiary aspect of the present invention, in the image printing apparatus described in the sixth subsidiary aspect described above, the paper feed/recording sheet information setting unit comprises a paper feed/recording sheet information selection unit which selects the registered specified values of paper size information and paper type information. This makes it possible to easily set registered specified values by using the paper feed/recording sheet information selection unit when the paper size information and paper type information of recording sheets are set in the paper feed unit. This can also prevent inaccurate information from being set.

According to the eighth subsidiary aspect of the present invention, the image printing apparatus described in any one of the first main aspect and the first to seventh subsidiary aspects described above further comprises a paper feed/recording sheet information changing unit which can, upon receiving a mismatch notification, change the settings of the paper size information and paper type information in the paper feed unit in which a mismatch is determined. This makes it possible to change the settings of the paper size information and paper type information of recording sheets which can be fed in the paper feed unit so as to allow image printing upon changing the recording sheets exhibiting a mismatch to recording sheets exhibiting a paper size match and a paper type match after mismatch notification. Note that in the paper feed/recording sheet information changing unit, if the paper size information and paper type information of recording sheets which can be fed in the paper feed unit can be changed by using the set information of the paper size information and paper type information of recording sheets used for the tandem output operation, the operation of changing settings is facilitated.

According to the ninth subsidiary aspect of the present invention, in the image printing apparatus described in the eighth subsidiary aspect described above, the paper feed/recording sheet information changing unit comprises a paper feed/recording sheet information selection unit which selects the registered specified values of paper size information and paper type information. This makes it possible to easily set and change the paper size information and paper type information of recording sheets which can be fed in the paper feed unit by selecting information from registered specified values.

According to the 10th subsidiary aspect of the present invention, in the image printing apparatus according to any one of the first main aspect and the first to ninth subsidiary aspects described above, the paper feed unit has a plurality of paper feed trays and can feed recording sheets using a selected paper feed tray. This makes it possible to feed recording sheets from a selected one of the plurality of paper feed trays. In addition, when a plurality of paper feed trays are provided, paper size information and paper type information in the paper feed unit are set for each paper feed tray.

According to the 11th subsidiary aspect of the present invention, the image printing apparatus described in the 10th subsidiary aspect described above comprises a paper feed tray selection input unit which can perform paper feeding operation by selecting a paper feed tray in place of a paper feed tray which has been selected for paper feeding operation, upon receiving mismatch notification. With this operation, when one or both of the paper size and paper type of recording sheets on the paper feed tray which has been selected in advance for paper feeding operation exhibit mismatches, the operator is given an opportunity to select a paper feed tray matching the designated paper size and designated paper type by selecting another paper feed tray using the paper feed tray selection input unit. In addition, the operator can select a paper feed tray having recording sheets to which the currently selected recording sheets are to be changed so as to match the designated paper size and designated paper type. This makes it possible to change recording sheets while avoiding a paper feed tray on which the operator does not want to change the type of recording sheets. A selected paper feed tray can be set as a target for which matches/mismatches between pieces of paper size information and paper type information are determined by the comparison and determination unit.

According to the 12th subsidiary aspect of the present invention, the image printing apparatus according to the 10th subsidiary aspect described above performs match/mismatch determination with respect to the paper sizes and paper types of recording sheets on a plurality of paper feed trays. This makes it possible to search for a paper feed tray exhibiting paper size match and a paper type match by performing match/mismatch determination with respect to the paper sizes and paper types of recording sheets on a plurality of paper feed trays. This determination can be sequentially performed in accordance with a predetermined paper feed tray determination order, and can be applied to the paper feed unit in the APS mode.

According to the 13th subsidiary aspect of the present invention, the image printing apparatus described in the 12th subsidiary aspect described above is characterized in that a paper feed tray for which the comparison and determination unit determines that it exhibits a paper size match and a paper type match is set as a paper feed tray from which recording sheets can be fed. With this operation, paper size and paper type match/mismatch determination is performed in the above manner with respect to a plurality of paper feed trays, and a paper feed tray for which it is determined that it exhibits a paper size match and a paper type match is set as a paper feed tray from which recording sheets can be fed. This makes it possible to automatically select and feed proper recording sheets.

According to the 14th subsidiary aspect of the present invention, the image printing apparatus described in the 12th subsidiary aspect described above comprises a paper feed tray selection input unit which can select a paper feed tray from which recording sheets can be fed when the comparison and determination unit determines either a paper size mismatch or a paper type mismatch in all paper feed trays. With this arrangement, if a paper size mismatch or a paper type mismatch is determined in all paper feed trays, the operator can select a paper feed tray from which recording sheets can be fed by using the paper feed tray selection input unit, and can set recording sheets exhibiting a paper size match and a paper type match on the paper feed tray. A selected paper feed tray can be set as a target for which the comparison and determination unit determines match/mismatch determination for paper size information and paper type information.

According to the 15th subsidiary aspect of the present invention, in the image printing apparatus described in any one of the first main aspect and the first to 14th subsidiary aspects described above, if the comparison and determination result obtained by the comparison and determination unit indicates that either the paper size or the paper type exhibits a mismatch, the image printing operation of the image printing unit is stopped. When recording sheets matching the received paper size information and paper type information can be fed from the paper feed unit, image printing is performed by using the recording sheets. With this operation, if the paper size or paper type of recording sheets which can be fed from the paper feed unit does not match that of recording sheets used for the tandem output operation, the image printing apparatus interrupts image printing. When recording sheets which can be fed match those used for the tandem output operation, image printing is performed. This makes it possible to avoid the tandem output operation with different print results and perform the tandem output operation only when identical print results can be obtained.

According to the 16th subsidiary aspect of the present invention, in the image printing apparatus according to the first main aspect, the mismatch notification unit notifies another image printing apparatus described above of a mismatch.

According to the 17th subsidiary aspect of the present invention, the image printing apparatus according to the second main aspect comprises a display unit which displays the mismatch notification. Therefore, mismatch notification can be displayed on the display unit, and the operator can easily and visually check the indication of the notification.

According to the 18th subsidiary aspect of the present invention, the image printing apparatus described in the second main aspect or the 17th subsidiary aspect described above further comprises a recording sheet information registration unit in which the specified values of the paper size information and paper type information of a plurality of recording sheets are registered in advance. This makes it possible to register the specified values of paper size information and paper type information in the recording sheet information registration unit in advance. Using the specified values as information realizes standardization.

According to the 19th subsidiary aspect of the present invention, the image printing apparatus described in the 18th subsidiary aspect described above further comprises a recording sheet information changing unit which changes the registered specified values of the paper size information and paper type information of recording sheets. This allows the recording sheet information changing unit to change registered information.

According to the 20th subsidiary aspect of the present invention, in the image printing apparatus described in the 18th or 19th subsidiary aspect described above, the paper feed setting unit can select values of the registered specified values of paper size information and paper type information. This makes it possible to easily make paper feed setting by using specified values. The paper feed setting unit can be constituted by, for example, a proper input unit and a display unit which displays registered paper size information and paper type information.

According to the 21st subsidiary aspect of the present invention, in the tandem image printing method described in the third main aspect, when the image printing apparatus which has received paper size information and paper type information is notified of a mismatch, a mismatch indication is displayed. This allows the operator to know that a mismatch has occurred in the image printing apparatus in which a paper size or paper type mismatch has occurred.

According to the 22nd subsidiary aspect of the present invention, in the tandem image printing method described in the third main aspect or the 21st subsidiary aspect described above, the image printing apparatus which has set sheet size information and paper type information and transmitted the set information to another image printing apparatus is notified of a mismatch. The image printing apparatus which has transmitted the paper size and the paper type can recognize mismatches when paper sizes and paper types of recording sheets mismatch each other between image printing apparatuses.

What is claimed is:

1. An image printing apparatus having a tandem output mode which allows transmission/reception of image data to/from at least another image printing apparatus through a communication unit for connecting the image printing apparatus to the other image printing apparatus so as to allow communication therebetween, thereby allowing a plurality of image printing apparatuses to perform image printing, comprising:
an image printing unit which prints an image;
a paper feed unit which feeds a recording sheet to said image printing unit;
a comparison and determination unit which determines, in the tandem output mode, a paper size and paper type match/mismatch by comparing paper size information and paper type information of another image printing apparatus which have been received by the communication unit with paper size information and paper type information of a recording sheet which can be fed from said paper feed unit; and
a mismatch notification unit which receives a determination result from said comparison and determination unit and notifies a mismatch when one or both of a paper size mismatch and a paper type mismatch has occurred.

2. An apparatus according to claim 1, wherein said mismatch notification unit is a display unit which displays a mismatch.

3. An apparatus according to claim 2, wherein said display unit displays an indication requiring a recording sheet exhibiting a paper size match and a paper type match.

4. An apparatus according to claim 2, wherein said display unit discriminatively displays at least a content of the mismatch.

5. An apparatus according to claim 1, further comprising a recording sheet information registration unit which sets and registers specified values of paper size information and paper type information of a plurality of recording sheets in advance.

6. An apparatus according to claim 5, further comprising a recording sheet information changing unit which changes registered specified values of paper size information and paper type information of a recording sheet.

7. An apparatus according to claim 1, further comprising a paper feed/recording sheet information registration unit which sets and registers paper size information and paper type information of a recording sheet in said paper feed unit.

8. An apparatus according to claim 7, wherein said paper feed/recording sheet information setting unit comprises a paper feed/recording sheet information selection unit which selects specified values of registered specified values of paper size information and paper type information.

9. An apparatus according to claim 1, further comprising a paper feed/recording sheet information changing unit which can change settings of paper size information and paper type information of a recording sheet in a paper feed unit in which a mismatch has occurred when the mismatch is notified.

10. An apparatus according to claim 9, wherein said paper feed/recording sheet information setting unit comprises a paper feed/recording sheet information selection unit which selects specified values of registered specified values of paper size information and paper type information.

11. An apparatus according to claim 1, wherein said paper feed unit includes a plurality of paper feed trays and allows a selected paper feed tray to feed a recording sheet.

12. An apparatus according to claim 11, further comprising a paper feed tray selection input unit which selects another paper feed tray in place of the paper feed tray which has been selected as a paper feed tray from which paper feed is to be performed, and allows the selected paper feed tray to perform paper feed when the mismatch is notified.

13. An apparatus according to claim 11, wherein said comparison and determination unit determines a paper size match/mismatch and a paper type match/mismatch with respect to a plurality of paper feed trays.

14. An apparatus according to claim 13, wherein a paper feed tray for which a paper size match and a paper type match are determined by said comparison and determination unit is allowed to perform paper feed.

15. An apparatus according to claim 13, further comprising a paper feed tray selection input unit which can select a paper feed tray which is allowed to perform paper feed when said comparison and determination unit determines that one or both of a paper size and a paper type exhibits a mismatch with respect to all paper feed trays.

16. An apparatus according to claim 1, wherein if a comparison and determination result obtained by said comparison and determination unit indicates that one or both of a paper size and a paper type exhibits a mismatch, image printing by said image printing unit is stopped, and when a recording sheet matching a received paper size and paper type is allowed to perform paper feed, image printing is performed by using the recording sheet.

17. An apparatus according to claim 1, wherein said mismatch notification unit notifies the other image printing apparatus of a mismatch.

18. An image printing apparatus having a tandem output mode which allows transmission/reception of image data to/from at least another image printing apparatus through a communication unit for connecting the image printing apparatus to the other image printing apparatus so as to allow communication therebetween, thereby allowing a plurality of image printing apparatuses to perform image printing, comprising:
an image printing unit which prints an image;
a paper feed unit which feeds a recording sheet to said image printing unit; and
a paper feed setting unit which sets a paper size and paper type of a recording sheet to be fed from said paper feed unit,
wherein in the tandem output mode, paper size information and paper type information set by said setting unit are transmitted through said communication unit, and when a recording sheet which can be fed in another image printing apparatus which has received the set sheet size information and paper type information does not match one or both of the set sheet size and paper type, a mismatch notification can be received from the other image printing apparatus through said communication unit.

19. An apparatus according to claim 18, further comprising a display unit which displays the mismatch notification.

20. An apparatus according to claim 18, further comprising a recording sheet information registration unit in which specified values of paper size information and paper type information of a plurality of recording sheets are registered in advance.

21. An apparatus according to claim 20, further comprising a recording sheet information changing unit which changes registered specified values of paper size information and paper type information of a recording sheet.

22. An apparatus according to claim 20, wherein said paper feed setting unit can select specific values of registered specific values of paper size information and paper type information.

23. A tandem image printing method of transmitting/receiving image data between a plurality of image printing apparatuses by communicatively connecting said plurality of image printing apparatuses to each other and making said plurality of image printing apparatuses perform image printing, comprising:
transmitting paper size information and paper type information set in one image printing apparatus to at least another image printing apparatus;
causing the other image printing apparatus which has received the set sheet size information and paper type information to compare a paper size and paper type of a recording sheet which can be fed therein with a paper size and paper type based on the received set information; and
notifying a mismatch when one or both of a paper size and a paper type exhibits a mismatch.

24. A method according to claim 23, wherein when the mismatch is notified, the other image printing apparatus which has received paper size information and paper type information displays a mismatch.

25. A method according to claim 23, wherein the mismatch notification is transmitted to the image printing apparatus which has set sheet size information and paper type information and transmitted the set information to the other image printing apparatus.
